(19) United States
(12) Patent Application Publication
(10) Pub. No.: US 2011/0084871 A1
(43) Pub. Date: Apr. 14, 2011

(54) Cognitive tracking radar

(75) Inventors: Simon Haykin, Ancaster (CA); Amin Zia, Toronto (CA); Ienkaran Arasaratnam, Hamilton (CA); Yanbo Xue, Hamilton (CA)

(73) Assignee: MCMASTER UNIVERSITY, Hamilton (CA)

(21) Appl. No.: 12/588,346

(22) Filed: Oct. 13, 2009

(51) Int. Cl. G01S 13/00

(52) U.S. Cl. 342/82; 342/90

(57) ABSTRACT

Methods and systems relating to a cognitive tracking radar system. A radar system determines an immediately preceding state of a target being tracked. Based on this immediately preceding state, the system determines parameters and waveforms which may be used to better illuminate the target. These parameters and waveforms are then used when illuminating the target. The state of the target is then measured from the reflected returns of the illuminating waveform. The newly received measurements then form the basis for the new state of the target and the procedure is repeated.

### TECHNICAL FIELD

The present invention relates to radar technology. More specifically, the present invention relates to radar technology that enables a feedback between a radar's transmitter and receiver to ensure that a target being tracked is properly illuminated.

### BACKGROUND OF THE INVENTION

The evolution of radar systems has been remarkable over the several past decades, thanks to the advancement of digital signal processing, computation and artificial intelligence. Most of the researches in radar society have been focused at the receiver's end. The absence of feedback link from the receiver to the transmitter is one of, if not only, the aspects that was studied recently as a waveform design problem. Why should we be concerned about the absence of this feedback link? The answer to this question is twofold:
linkage of the receiver to the transmitter makes the radar system into a closed-loop feedback control system, whereby the operation of the transmitter is coordinated with that of the receiver;
global feedback is the facilitator of cognition

The idea of adding global feedback loop to current radar systems is inspired by the echolocation system of the bat or dolphin, which has been known to exist for millions of years. To be more specific, the bat is capable of adjusting its transmitting signal in a real-life fashion during the course of flying toward the target.

However, at the heart of the problem of designing a practical cognitive radar system is the Bayesian filter, an optimal estimator of the state of the target being tracked. Approximation of the Bayesian filter has engaged many researchers for over four decades, thereby coming up with a variety of solutions from the extended Kalman filter to particle filters. Previous solutions have been found wanting for one reason or another.

The present invention therefore seeks to provide methods and systems that allow for a practical cognitive radar system.

### SUMMARY OF INVENTION

The present invention provides methods and systems relating to a cognitive tracking radar system. A radar system determines an immediately preceding state of a target being tracked. Based on this immediately preceding state, the system determines parameters and waveforms which may be used to better illuminate the target. These parameters and waveforms are then used when illuminating the target. The state of the target is then measured from the reflected returns of the illuminating waveform. The newly received measurements then form the basis for the new state of the target and the procedure is repeated.

In a first aspect, the present invention provides a method for operating a radar system for tracking a target, the radar system having a transmitter and a receiver, the method comprising:
a) determining an immediately preceding state of said target;
b) based on said immediately preceding state, predicting an expected state of said target;
c) based on said expected state of said target, determining parameters for use in illuminating said target;
d) using said transmitter to illuminate said target based on said parameters;
e) receiving radiation reflected from said target;
f) determining a current state of said target based on radiation received in step e)
g) using said current state as said immediately preceding state, repeating steps b)-g).

In a second aspect, the present invention provides a system for iteratively tracking a target, the system comprising:
a transmitter for transmitting electromagnetic radiation to said target;
a receiver for receiving reflected radiation from said target;
processing means for receiving data related to said reflected radiation received by said receiver, said processing means determining parameters to be used by said transmitter when illuminating said target by transmitting said electromagnetic radiation; wherein
said transmitter receives said parameters from said processing means, said parameters being determined by said processing means based on a predicted state of said target;
said processing means determines said predicted state based on an immediately preceding state of said target as derived from said reflected radiation received by said receiver.

In a third aspect, the present invention provides computer readable media having stored thereon computer readable instruction which, when executed, executes a method for approximating a discrete-time Bayesian filter estimation that has a time update and a measurement update, said time update being estimated by a method comprising:

### a) Factorize

P_{k-1|k-1}=S_{k-1|k-1}S_{k-1|k-1}^{T}

using an assumption that at time k that a posterior density function p(xₖ₋₁|Dₖ₋₁)= [symbol] (\hat{x}_{k-1|k-1},P_{k-1|k-1}) is known
b) Evaluate cubature points (i=1, 2, . . . , m)

X_{i,k-1|k-1}=S_{k-1|k-1}ξᵢ+\hat{x}_{k-1|k-1}

where m=2ₙ_{ₓ}.
c) Evaluate propagated cubature points (i=1, 2, . . . , m)

X_{i,k|k-1}*=f(X_{i,k-1|k-1},uₖ₋₁)

d) Estimate a predicted state

$${\hat{x}}_{k \vert k - 1} = \frac{1}{m} {\sum }_{i = 1}^{m} {X}_{i , k \vert k - 1}^{*}$$

e) Estimate a predicted error covariance

$${P}_{k \vert k - 1} = \frac{1}{m} {\sum }_{i = 1}^{m} {X}_{i , k \vert k - 1}^{*} {X}_{i , k \vert k - 1}^{* T} - {\hat{x}}_{k \vert k - 1} {\hat{x}}_{k \vert k - 1}^{T} + {Q}_{k - 1}$$

wherein said measurement update being estimated by a method comprising:

### a) Factorize

P_{k|k-1}=S_{k|k-1}S_{k|k-1}^{T}

b) Evaluate cubature points (i=1, 2, . . . , m)

X_{i,k|k-1}=S_{k|k-1}ξᵢ+\hat{x}_{k|k-1}

c) Evaluate said propagated cubature points (i=1, 2, . . . , m)

Z_{i,k|k-1}=h(X_{i,k|k-1},uₖ₋₁)

d) Estimate a predicted measurement

$${\hat{z}}_{k \vert k - 1} = \frac{1}{m} {\sum }_{i = 1}^{m} {Z}_{i , k \vert k - 1}$$

e) Estimate an innovation covariance matrix

$${P}_{zz , k \vert k - 1} = \frac{1}{m} {\sum }_{i = 1}^{m} {Z}_{i , k \vert k - 1} {Z}_{i , k \vert k - 1}^{T} - {\hat{z}}_{k \vert k - 1} {\hat{z}}_{k \vert k - 1}^{T} + {R}_{k}$$

f) Estimate a cross-covariance matrix

$${P}_{xz , k \vert k - 1} = {\sum }_{i = 1}^{m} {w}_{i} {X}_{i , k \vert k - 1} {Z}_{i , k \vert k - 1}^{T} - {\hat{x}}_{k \vert k - 1} {\hat{z}}_{k \vert k - 1}^{T}$$

g) Estimate a Kalman gain

Wₖ=P_{xz,k|k-1}P_{zz,k|k-1}⁻¹.

h) Estimate an update state

\hat{x}_{k|k}=\hat{x}_{k|k-1}+Wₖ(zₖ−\hat{z}_{k|k-1})

i) Estimate a corresponding error covariance

P_{k|k}=P_{k|k-1}−WₖP_{zz,k|k-1}Wₖ^{T}.

### BRIEF DESCRIPTION OF THE DRAWINGS

The embodiments of the present invention will now be described by reference to the following figures, in which identical reference numerals in different figures indicate identical elements and in which:

FIG. 1 is a diagram illustrating the ballistic trajectory of a target to be tracked;

FIG. 2 is a track of a maneuvering aircraft's path;

FIG. 3 illustrate plots of the performance of one embodiment of the invention for a falling object tracking without bandwidth constraint;

FIG. 4 illustrate plots of the performance of one embodiment of the invention for a falling object tracking with bandwidth equal to 100 MHz;

FIG. 5 illustrate plots of the performance of one embodiment of the invention for a falling object tracking with bandwidth equal to 50 MHz;

FIG. 6 illustrate plots of the performance of one embodiment of the invention for a falling object tracking with bandwidth equal to 30 MHz;

FIG. 7 illustrate plots of the performance of one embodiment of the invention for a falling object tracking with bandwidth equal to 20 MHz;

FIG. 8 illustrates accumulated root mean square error for altitude vs. bandwidth for the invention and for a fixed waveform radar system;

FIG. 9 illustrates accumulated root mean square error for velocity vs. bandwidth for the invention and for a fixed waveform radar system;

FIG. 10 illustrates accumulated root mean square error for ballistic coefficient vs. bandwidth for the invention and for a fixed waveform radar system;

FIG. 11 shows performance for maneuvering target tracking without bandwidth constraint for the invention and for a fixed waveform (FWF) radar;

FIG. 12 shows performance for maneuvering target tracking with bandwidth equal to 100 MHz for the invention and for a fixed waveform (FWF) radar;

FIG. 13 shows performance for maneuvering target tracking with bandwidth equal to 50 MHz for the invention and for a fixed waveform (FWF) radar;

FIG. 14 shows performance for maneuvering target tracking with bandwidth equal to 30 MHz for the invention and for a fixed waveform (FWF) radar;

FIG. 15 shows performance for maneuvering target tracking with bandwidth equal to 20 MHz for the invention and for a fixed waveform (FWF) radar;

FIG. 16 shows the accumulated root mean square error (RMSE) for range vs. bandwidth for both the invention and a conventional radar system;

FIG. 17 shows the accumulated root mean square error (RMSE) for velocity vs. bandwidth for both the invention and a conventional radar system; and

FIG. 18 is a block diagram of a system according to one aspect of the invention.

### DETAILED DESCRIPTION OF THE INVENTION

At the heart of Cognitive Tracking Radar (CTR) is how to optimally design the waveform iteratively by fully utilizing the information fed back from the radar receiver. This is addressed as a waveform-agile sensing problem in.

The control theoretic approach and information theoretic approach are two main streams in the literature for this field:
From the viewpoint of control theory, the waveform is selected based on the constraints on desired peak or average power, or minimization of mean squared error (MSE) of the tracker. The control input is the aggregation of the parameters of the radar waveform. The present invention falls into this category.
From the viewpoint of information theory, an optimal waveform is the one that maximizes the mutual information between targets and waveform-dependent observations.

Cognitive tracking radar (CTR) is defined as a complex dynamic system whose
receiver learns, iteratively, from experience gained through interactions with the environment,
transmitter adapts its illumination of the environment in an optimal manner in accordance with information about the environment passed on to it by the receive, and
feedback link coordinates the operations of the transmitter and receiver in a synchronous manner.

One part of CTR is a dynamic transmitted signal-selection procedure based on a feedback link from the radar receiver to the transmitter. Although there are many forms on transmitted signal models, one option for the present invention is the use of the linear frequency-modulated (LFM) chirp signal. The waveform structure of LFM chirp is expressed as the following complex Gaussian envelope:

\tilde{s}(t)=a(t)exp(j2πbξ(t/tᵣ)), |t|≦T/2+t_{f} (1)

where a(t) is a trapezoidal envelope with rise and fall time t_{f}<<T/2, ξ(t)=t/γ+(t+λ/2)²/2 is the phase function, λ is the duration of the Gaussian envelope, b is a scalar denoting the chirp rate and tᵣ is the reference time. We denote by θ=[λ, b] two waveform parameters that will be optimized through Cognitive Waveform Selection (CWS) method below.

The reflected transmitted signal from target at the receiver is modeled as:

r(t)=s_{R}(t)+n(t) (2)

where n(t) is the receiver additive white Gaussian noise. Here we consider a narrowband model for the received signal as follows:

s_{R}(t)=\sqrt{2}Re[\sqrt{E_{R}}\tilde{s}(t−τ)exp(j2π(f_{c}t+νt))] (3)

where E_{R} is the received signal energy and f_{c} is the carrier frequency of the transmitted signal \tilde{s}(t). In (3), τ=2r/c is the delay of the received signal where r is the range of the target and c is the speed of wave propagation. Also, ν=−2f_{c}\dot{r}/c is the Doppler shift. In this model, we assume that all frequencies in the transmitted signal have the same Doppler shift and therefore are shifted equally. This is a valid assumption if the time-bandwidth product (TBP) of the transmitted signal is small enough, i.e. (TBP<<c/2\dot{r}) where \dot{r} is the radial velocity of the target. This condition is easily met for tracking radars due to the very large speed of wave propagation c compared to the radial velocity of the target. The range and range-rate of the target are given by r=cτ/2 and \dot{r}=cν/(2f_{c}), respectively.

For the target dynamics and measurement model, we consider the model general form of a nonlinear dynamic system for the target with the following state-space model:

xₖ=f(xₖ₋₁)+vₖ (4)

and the measurement equation:

zₖ=h(xₖ)+wₖ(θₖ) (5)

where xₖε [symbol] is the state vector at discrete time index k and zₖε [symbol] is the vector of noisy measurements at time k. The vectors vₖε [symbol] is an i.i.d. process with zero mean and covariance Qₖ. The vector valued functions f: [symbol] [symbol] [symbol] and h: [symbol] [symbol] [symbol] are assumed to be smooth and otherwise arbitrary.

We assume that the measurement noise wₖε [symbol] is modeled by an i.i.d Gaussian process with zero mean and covariance Rₖ(θₖ). The vector of parameters θε [symbol] is a real-valued vector spanning the range of parameters defined by the transmitted signal library \tilde{s}(t) (see above).

The delay and Doppler shift of the received signal are estimated in the receiver. These estimates are then translated into range and range-rate measurement in (5). The accuracy of this estimation (represented by noise covariance Rₖ(θₖ)) is a function of transmitted signal parameters via our choice of the receiver narrowband ambiguity function:

$${AF}_{\tilde{s}} ( τ , v ) = {\int }_{- ∞}^{+ ∞} \tilde{s} ( t + \frac{τ}{2} ) {\tilde{s}}^{*} ( t - \frac{τ}{2} ) exp ( - j2π v t ) d t \qquad ( 6 )$$

where \tilde{s}* is the complex conjugate of the transmitted signal \tilde{s}.

We assume that the measurement covariance Rₖ(θₖ) achieves the Cramér-Rao lower bound (CRLB) of the range and range-rate estimators. The CRLB, in turn, can be obtained by inverting the Fisher information matrix (FIM) via the following equation:

$${R}_{k} ( {θ}_{k} ) = \frac{1}{η} Γ {I}_{f}^{- 1} Γ \qquad ( 7 )$$

where η is the signal-to-noise ratio (SNR),

$$Γ {=}^{Δ} diag [ \frac{c}{2} , \frac{c}{2 ( {f}_{c} )} ] .$$

In this equation I_{f} is the FIM corresponding to the estimation of the delay and the Doppler shift [τ ν]^{T} computed as the Hessian of the ambiguity function as follows:

$$\begin{matrix}{I}_{f} ( 1 , 1 ) = - \frac{{\partial }^{2} {AF}_{\tilde{s} ( τ , V )}}{\partial {τ}^{2}} {\vert}_{τ = 0 , v = 0} \\ = {\int }_{- \frac{λ}{2}}^{\frac{λ}{2}} ( {a}^{2} ( t ) + {a}^{2} ( t ) {Ω}^{2} ( t ) ) d t - {[ {\int }_{- \frac{λ}{2}}^{\frac{λ}{2}} {a}^{2} ( t ) Ω ( t ) d t ]}^{2}\end{matrix}$$

$$\begin{matrix}{I}_{f} ( 1 , 2 ) = - \frac{{\partial }^{2} {AF}_{\tilde{s} ( τ , V )}}{\partial τ \partial v} {\vert}_{τ = 0 , v = 0} \\ = {\int }_{- \frac{λ}{2}}^{\frac{λ}{2}} {ta}^{2} ( t ) {Ω}^{2} ( t ) d t\end{matrix}$$

$$\begin{matrix}{I}_{f} ( 2 , 2 ) = - \frac{{\partial }^{2} {AF}_{\tilde{s} ( τ , V )}}{\partial {v}^{2}} {\vert}_{τ = 0 , v = 0} \\ = {\int }_{- \frac{λ}{2}}^{\frac{λ}{2}} {t}^{2} {a}^{2} ( t ) d t ,\end{matrix}$$

where we know that I_{f}(1,2)=I_{f}(2,1). Here we defined

$$Ω ( t ) {=}^{Δ} 2 π ( b \frac{d}{d t} ξ ( \frac{t}{{t}_{r}} ) + {f}_{c} )$$

where b is the FM rate parameter, ξ(t/tᵣ) is the chirp phase function, and f_{c} is the carrier frequency defined in (1). Also, a(t) is the transmitted signal envelope function defined in (1).

For the special case of linear frequency modulated (LFM) chirp signal FIM is simplified into:

$${I}_{f} = {( 2 π )}^{2} η ( \begin{matrix}\frac{1}{2 {( 2 π )}^{2} {λ}^{2}} + 2 {b}^{2} {λ}^{2} & 2 b {λ}^{2} \\ 2 b {λ}^{2} & \frac{{λ}^{2}}{2}\end{matrix} ) \qquad ( 8 )$$

In the following sections, we use Rₖ(θₖ) to optimize the transmitted, signal parameters θ.

From the above, the kinematics of the radar target, namely, range, velocity, and possibly acceleration, define the state of the target. Naturally, the state is hidden from the receiver (observer), and the only available information about the target is contained in the radar returns, denoted by zₖ. The problem we therefore have to solve is that of nonlinear sequential state estimation, given the sequence of measurements zₖ={z₁, z₂, z₃, . . . zₜ}.

The optimal solution to this state-estimation problem is the Bayesian filter, the origin of which is traced to Ho and Lee. This filter embodies the following pair of updates:
(i) Time update, which defines the predictive distribution

p(xₖ|zₖ₋₁)=∫_{R}_{ⁿ}p(xₖ|xₖ₋₁)p(xₖ₋₁|zₖ₋₁)dxₖ₋₁

where p(xₖ|xₖ₋₁) is the transition prior distribution from the state xₖ₋₁ to xₖ or simply the prior, and p(xₖ₋₁|zₖ₋₁) is the old posterior distribution or simply the posterior at time index k−1.
(ii) Measurement update, which defines the updated posterior in terms of the predictive distribution, as shown by

$$p ( {x}_{k} \vert {z}_{k} ) = \frac{1}{{Z}_{k}} p ( {x}_{k} \vert {z}_{k - 1} ) p ( {z}_{t} \vert {x}_{k} )$$

where p(zₜ|xₖ) is the likelihood function, and

Zₜ=∫p(xₖ|zₖ₋₁)p(zₜ|xₖ)dxₖ

is the partition function whose sole role is normalization.

The Bayesian filter is an optimal estimator of the state, at least in a conceptual sense. Unfortunately, when the state-space model is nonlinear, non-Gaussian or both, the time update above defies a closed-form solution, in which case we resort to numerical methods for its approximation.

The Cubature Kalman filter (CKF) is the closest known approximation to the discrete-time Bayesian filter that could be designed in a nonlinear setting under the key assumption that the predictive density of the joint state-measurement random variable is Gaussian. Under this assumption, the cubature Kalman filter solution reduces to how to compute integrals, whose integrands are of the form

nonlinear function×Gaussian

The CKF has some unique properties, summarized as follows:
Property 1: The cubature Kalman filter (CKF) is a derivative-free on-line sequential-state estimator, relying on integration from one step to the next for its operation.
Property 2: Approximations of the moment integrals in the Bayesian filter are all linear in the number of function evaluations.
Property 3: Computational complexity of the cubature Kalman filter as a whole, grows as n³, where n is the dimensionality of the state space. The CKF eases the curse-of-dimensionality problem but, by itself, will not overcome it.
Property 4: The cubature Kalman filter completely preserves second-order information about the state that is contained in the observations.
Property 5: Regularization is built into the constitution of the cubature Kalman filter by virtue of the fact that the prior is known to play a role equivalent to regularization.
Property 6: The cubature Kalman filter inherits properties of the linear Kalman filter, including square-root filtering for improved accuracy and reliability.
Property 7: Under the Gaussian assumption, the cubature Kalman filter is the closest known direct approximation to the Bayesian filter, outperforming the extended Kalman filter and the central-difference Kalman filter.

Applicability of the cubature Kalman filter can be expanded to facilitate its use in a non-Gaussian environment through the use of the Gaussian-sum approximation. The rationale behind this expansion is that a non-Gaussian distribution can be approximated as the sum of a limited number of independent Gaussian distributions.

Insofar as the implementation of a cognitive tracking radar is concerned, we may thus implement the approximate Bayesian filter for perceiving the radar environment in the best computationally possible manner by using the cubature Kalman filter. For a Gaussian environment, the basic form of the CKF suffices; for a non-Gaussian environment, the expanded form of the CKF using the Gaussian-sum approximation may well suffice.

Next, we discuss the CKF's two-step update cycle, namely, the time update and the measurement update. Note that here the input signal, commonly denoted by uₖ in CKF formulations, is the transmit waveform parameters denoted by θ.

In the time update step, the CKF computes the mean \hat{x}_{k|k-1} and the associated covariance P_{k|k-1} of the Gaussian predictive density numerically using cubature rules. We write the predicted mean

\hat{x}_{k|k-1}= [symbol] (xₖ|Dₖ₋₁) (9)

where [symbol] (•) is the statistical expectation operator. Substituting (4) into (9) yields

\hat{x}_{k|k-1}= [symbol] [f(xₖ₋₁)+qₖ|Dₖ₋₁] (10)

Because qₖ is assumed to be zero-mean and uncorrelated with the measurement sequence, we get

$$\begin{matrix}{\hat{x}}_{k \vert k - 1} = E [ f ( {x}_{k - 1} ) \vert {D}_{k - 1} ] \\ = {\int }_{{R}^{nz}} f ( {x}_{k - 1} ) p ( {x}_{k - 1} \vert {D}_{k - 1} ) d {x}_{k - 1} \\ = {\int }_{{R}^{nx}} f ( {x}_{k - 1} ) 𝒩 ( {x}_{k - 1} \text{:} {\hat{x}}_{k - 1 \vert k - 1} , {P}_{k - 1 \vert k - 1} ) d {x}_{k - 1}\end{matrix} \qquad ( 11 )$$

where [symbol] (.,.) is the conventional symbol for a Gaussian density. Similarly, we obtain the associated error covariance

$$\begin{matrix}{P}_{k \vert k - 1} = E [ ( {x}_{k} - {\hat{x}}_{k \vert k - 1} ) {( {x}_{k} - {\hat{x}}_{k \vert k - 1} )}^{T} \vert {z}_{1 : k - 1} ] \\ = {\int }_{{R}^{nz}} f ( {x}_{k - 1} ) {f}^{T} ( {x}_{k - 1} ) \\ 𝒩 ( {x}_{k - 1} : {\hat{x}}_{k - 1 \vert k - 1} \cdot {P}_{k - 1 \vert k - 1} ) d {x}_{k - 1} - \\ {\hat{x}}_{k \vert k - 1} {\hat{x}}_{k \vert k - 1}^{T} + {Q}_{k - 1} .\end{matrix} \qquad ( 12 )$$

For the measurement update, it is known that the innovation process is not only white but also zero-mean Gaussian when the additive measurement noise is Gaussian and the predicted measurement is estimated in the least squares error sense. In this case, we write the predicted measurement density also called the filter likelihood density

p(zₖ|Dₖ₋₁)= [symbol] (zₖ;\hat{z}_{k|k-1},P_{zz,k|k-1}) (13)

where the predicted measurement and the associated covariance respectively are given by

\hat{z}_{k|k-1}=∫ [symbol] h(xₖ)N(xₖ;\hat{x}_{k|k-1},P_{k|k-1})dxₖ (14)

P_{zz,k|k-1}=∫ [symbol] h(xₖ)h^{T}(xₖ)N(xₖ;\hat{x}_{k|k-1},P_{k|k-1})dxₖ−\hat{z}_{k|k-1}\hat{z}_{k|k-1}^{T}+Rₖ(θₖ). (15)

Hence, we write the Gaussian conditional density of the joint state and the measurement:

$$p ( {[ {x}_{k}^{T} {z}_{k}^{T} ]}^{T} \vert {D}_{k - 1} ) = N ( ( \begin{matrix}{\hat{x}}_{k \vert k - 1} \\ {\hat{z}}_{k \vert k - 1}\end{matrix} ) , ( \begin{matrix}{P}_{k \vert k - 1} & {P}_{xz , k \vert k - 1} \\ {P}_{xz , k \vert k - 1}^{T} & {P}_{zz , k \vert k - 1}\end{matrix} ) ) \qquad ( 16 )$$

where the cross-variance is

P_{xz,k|k-1}=∫ [symbol] xₖh^{T}(xₖ)N(xₖ;\hat{x}_{k|k-1},P_{k|k-1})dxₖ−\hat{x}_{k|k-1}\hat{z}_{k|k-1}^{T} (15)

On the receipt of a new measurement zₖ, the CKF computes the posterior density p(xₖ|Dₖ) from (16) yielding

$$\begin{matrix}p ( {x}_{k} \vert {D}_{k} ) = \frac{p ( {x}_{k} , {z}_{k} \vert {D}_{k - 1} )}{p ( {z}_{k} \vert {D}_{k - 1} )} \\ = N ( {x}_{k} ; {\hat{x}}_{k \vert k} , {P}_{k \vert k} )\end{matrix} \qquad ( 18 )$$

where

\hat{x}_{k|k}=\hat{x}_{k|k-1}+Gₖ(zₖ−\hat{z}_{k|k-1} (19)

P_{k|k}=P_{k|k-1}−GₖP_{zz,k|k-1}Gₖ^{T} (20)
with the Kalman gain

Gₖ=P_{xz,k|k-1}P_{zz,k|k-1}⁻¹ (21)

The CKF theory reduces to the Kalman filter for a linear Gaussian system case. The CKF numerically computes Gaussian weighted integrals that are present in (11)-(12), (14)-(15) and (17) using cubature rules as outlined below.

In general, cubature rules are constructed to numerically compute multi-dimensional weighted integrals. The CKF specifically uses a third-degree cubature rule to numerically compute Gaussian weighted integrals. The third-degree cubature rule is exact for integrands being polynomials of degree up to three or any odd integer. For example, we use the cubature rule to approximate an n-dimensional Gaussian weighted integral as follows:

$${\int }_{{R}^{n}} f ( x ) 𝒩 ( x ; μ \cdot Σ ) d x \approx \frac{1}{2 n} {\sum }_{i = 1}^{2 n} f ( μ + \sqrt{Σ} {α}_{i} )$$

where a square-root factor of the covariance Σ satisfies the relationship Σ=\sqrt{Σ}\sqrt{Σ}^{T} and the set of 2n cubature points are given by

$${α}_{i} = \{ \begin{matrix}\sqrt{n} {e}_{i} , & i = 1 , 2 … n \\ - \sqrt{n} {e}_{i - n} , & i = n + 1 , n + 2 … 2 n\end{matrix} \qquad ( 22 )$$

with eᵢε [symbol] denoting the i-th elementary column vector. For a detailed exposition of how to derive cubature points, the reader may consult I. Arasaratnam, Cubature Kalman Filtering: Theory & Applications. Ph.d. thesis, Department of ECE, McMaster University, Hamilton, Ontario, Canada, April 2009 which is incorporated herein by reference.

For optimal performance, every time the target is illuminated by the radar's transmitter, it is possible that a different waveform may be used. With recent advances in computational power, a different waveform can be chosen for each time instance of signal transmission. Different transmit waveforms have different properties which results in different estimation accuracies. A Non-Myopic Cognitive Waveform-Selection (NM-CWS) method can be used to select the waveform. Before proceeding to the Cognitive Waveform-Selection (CWS) method, let us define the information available to the waveform-selection module at time k and call it the information vector:

Iₖ [symbol] (z^{k-1},θ^{k-1}) (23)

It should be noted that as defined previously we have: (z^{k-1}, θ^{k-1})=(z₀, z₁, . . . , θ₀, θ₁, . . . , θₖ₋₁). It is important to notice that the waveform-selection module has only access to the hidden states x^{k-1} through the noisy measurements z^{k-1}. Also, it is essential to discriminate between the information vector available in this case and conventional control systems in the sense that here the method does not have access to the measured value zₖ but rather the main purpose of the algorithm is to acquire the optimal measurement by means of CWS.

In particular, the CWS module selects the transmitted signal parameters θₖ in order to minimize the tracking expected mean square error (MSE):

g(θₖ,Iₖ)=E_{z}_{ₖ}_{,x}_{ₖ}_{|I}_{ₖ}_{,θ}_{ₖ}{(xₖ−\hat{x}_{k|k}(Iₖ,xₖ,zₖ,θₖ))^{T}Λ(xₖ−\hat{x}_{k|k}(Iₖ,xₖ,zₖ,θₖ))} (24)

where the variable \hat{x}_{k|k} is the expected updated state (see Eq. 19) given all previous measurements z^{k-1}, and the expected state and measurement xₖ and zₖ, respectively when the parameter θₖ is chosen. Note also that since the state and measurement variables are not known, the cost function is summed over all their expected values. The matrix Λ is a weighting matrix commonly used in tracking to maintain the consistency between different components of the state with different units. We will discuss about this matrix later in the following sections. For brevity in notations, throughout this document, we omit the explicit representation of the dependence of this variable on (I, k, xₖ, zₖ, θₖ).

We have the expectation:

$$\begin{matrix}\begin{matrix}{g}_{k} ( {θ}_{k} , {I}_{k} ) = {E}_{{z}_{k} , {x}_{k} \vert {I}_{k} , θ} \{ {( {x}_{k} - {\hat{x}}_{k \vert k} )}^{T} Λ ( {x}_{k} - {\hat{x}}_{k \vert k} ) \} \\ = {\int }_{{z}_{k}} {\int }_{{x}_{k}} p ( {z}_{k} \vert {x}_{k} , {I}_{k} , {θ}_{k} ) p ( {x}_{k} \vert {I}_{k} , {θ}_{k} ) \\ \{ {( {x}_{k} - {\hat{x}}_{k \vert k} )}^{T} Λ ( {x}_{k} - {\hat{x}}_{k \vert k} ) d {x}_{k} d {z}_{k} \\ = {\int }_{{z}_{k}} {\int }_{{x}_{k}} p ( {z}_{k} \vert {x}_{k} , {I}_{k} , {θ}_{k} ) p ( {x}_{k} \vert {I}_{k} ) \\ \{ {( {x}_{k} - {\hat{x}}_{k \vert k} )}^{T} Λ ( {x}_{k} - {\hat{x}}_{k \vert k} ) \} d {x}_{k} d {z}_{k}\end{matrix} & ( 25 ) \\ \begin{matrix} = {\int }_{{z}_{k}} {\int }_{{x}_{k}} p ( {z}_{k} \vert {x}_{k} , {θ}_{k} ) p ( {x}_{k} \vert {I}_{k} ) \\ \{ {( {x}_{k} - {\hat{x}}_{k \vert k} )}^{T} Λ ( {x}_{k} - {\hat{x}}_{k \vert k} ) \} d {x}_{k} d {z}_{k}\end{matrix} & ( 26 ) \\ \begin{matrix} = {\int }_{{z}_{k}} {\int }_{{x}_{k}} p ( {z}_{k} \vert {x}_{k} , {θ}_{k} ) p ( {x}_{k} \vert {z}^{k - 1} , {θ}^{k - 1} ) \\ \{ {( {x}_{k} - {\hat{x}}_{k \vert k} )}^{T} Λ ( {x}_{k} - {\hat{x}}_{k \vert k} ) \} d {x}_{k} d {z}_{k}\end{matrix} & ( 27 )\end{matrix}$$

where in (25) we used the fact that given the information vector, Iₖ the state xₖ is independent of any choice of parameters θₖ. Also in (26) and by referring to measurement equation (5), we noticed that given xₖ, the likelihood of the measurement zₖ is independent of Iₖ. The first term in (27) is the likelihood of measurement xₖ that is available from the state-space measurement equation (5). Also, the second term is the expected updated state given all the previous measurements that are obtained from the tracking filter (see Eq. (18)). The expected updated state \hat{x}_{k|k}, as stated in (19), is the estimated state given the predicted measurement z^{k} and all the previous measurements z^{k-1} that can be computed using another state tracking filter.

A closer look at the cost function in (27) reveals that the integrals over the measurement zₖ and the state zₖ are inseparable and therefore very difficult to compute. In particular, the state prediction \hat{x}_{k|k} is a function of zₖ which is, in turn, a function of the state xₖ. Therefore, the integrand of the outer integral over zₖ's is itself a function of xₖ.

Several methods for the computation of the cost function in (27) are now presented.

The cost function can be approximated using the Monte Carlo simulation method by replacing the integrals with summations over state and measurement points generated as samples of their respective probability distributions. From (27), we have:

$$\begin{matrix}{g}_{k} ( {θ}_{k} , {I}_{k} ) = {\int }_{{z}_{k}} {\int }_{{x}_{k}} p ( {z}_{k} \vert {x}_{k} , {θ}_{k} ) p ( {x}_{k} \vert {z}^{k - 1} , {θ}^{k - 1} ) \\ \{ {( {x}_{k} - {\hat{x}}_{k \vert k} )}^{T} Λ ( {x}_{k} - {\hat{x}}_{k \vert k} ) \} d {x}_{k} d {z}_{k} \\ \approx \frac{1}{{N}_{x}} {\sum }_{n = 1}^{{N}_{x}} \frac{1}{{N}_{z}} {\sum }_{p = 1}^{{N}_{z}} {( {x}_{n} - {\hat{x}}_{n \vert {z}_{p} , {z}^{k - 1}} )}^{T} Λ ( {x}_{n} - {\hat{x}}_{n \vert {z}_{p} , {z}^{k - 1}} ) ,\end{matrix} \qquad ( 28 )$$

where xₙ=1, . . . , Nₓ are independent samples generated according to the posterior distribution p(xₖ|zₖ₋₁, θₖ₋₁) obtained by the tracking filter. Also xₚ={1, . . . , Nₚ} are independent samples from the likelihood function p(zₖ|xₖ,θk). The estimate \hat{x}_{n|z}_{ₚ}_{,z}_{^{k−1}} is the estimate of xₓ given the predicted measurement zₚ and all the previous measurements z^{k-1} that can be computed using another state tracking filter.

The approximated cost function is then minimized with respect to θ by means of a stochastic search algorithm, referred to as the simultaneous perturbation stochastic approximation (SPSA) method. In this method, after approximating the gradient of the approximated cost function, a perturbation method is used to find θ that results in the steepest descent of the cost function.

This SPSA method, even for the myopic formulation of the optimization, suffers from the curse of dimensionality. One reason that dimensionality becomes an issue is that both the cost function and its gradient need to be evaluated at many sample points for each iteration of the estimation and for many values of the parameters θ. Moreover, computation of the expected updated state estimate \hat{x}_{n|z}_{ₚ}_{,z}_{^{k−1}} requires another tracking filter with similar complexity.

Another approximation, a cubature-based approximation, may also be used. For brevity of notations we denote the quadratic form in (27) by

D(xₖ,zₖ,Iₖθₖ) [symbol] (xₖ−\hat{x}_{k|k})^{T}Λ(xₖ−\hat{x}_{k|k}) (29)

In (29), note that D is a function of (xₖ, Iₖ, zₖ, θₖ). By assuming Gaussian distributed noise processes for the state-space model, the cost function in (27) can be rewritten as Eqn 30:

$$\begin{matrix}{g}_{k} ( {θ}_{k} , {I}_{k} ) = {\int }_{{z}_{k}} {\int }_{{x}_{k}} p ( {z}_{k} \vert {x}_{k} , {θ}_{k} ) p ( {x}_{k} \vert {z}^{k - 1} , {θ}^{k - 1} ) \\ \{ D ( {x}_{k} , {z}_{k} , {I}_{k} , {θ}_{k} ) \} d {x}_{k} d {z}_{k} \\ = {\int }_{{x}_{k}} p ( {x}_{k} \vert {z}^{k - 1} , {θ}^{k - 1} ) {\int }_{{z}_{k}} p ( {z}_{k} \vert {x}_{k} , {θ}_{k} ) \\ \{ D ( {x}_{k} , {z}_{k} , {I}_{k} , {θ}_{k} ) \} d {z}_{k} d {x}_{k} \\ = {\int }_{{x}_{k}} 𝒩 ( {x}_{k} , {\hat{x}}_{k \vert k - 1} , {P}_{k \vert k - 1} ) \\ {\int }_{{z}_{k}} 𝒩 ( {z}_{k} , h ( {x}_{k} ) , {R}_{k} ( {θ}_{k} ) ) \\ \{ D ( {x}_{k} , {z}_{k} , {I}_{k} , {θ}_{k} ) \} d {z}_{k} d {x}_{k}\end{matrix}$$

where \hat{x}_{k|k-1}, P_{k|k-1}, and Rₖ(θₖ) are defined in (11), (12), and (7), respectively.

For each fixed xₖ, the inner integral in (30) is in the form of a “Gaussian×nonlinear function”, which by using the cubature rule, can be written as

$$\begin{matrix}\begin{matrix}{\int }_{{z}_{k}} 𝒩 ( {z}_{k} \text{:} h ( {x}_{k} ) , {R}_{k} ( {θ}_{k} ) ) \\ \{ D ( {x}_{k} , {z}_{k} , {I}_{k} , {θ}_{k} ) \} d {z}_{k}\end{matrix} \approx {\sum }_{i = 1}^{2 n} D ( {x}_{k} , [ h ( {x}_{k} ) + {{R}_{k} ( {θ}_{k} )}^{1 / 2} {α}_{i} ] , {I}_{k} , {θ}_{k} ) \\ {=}^{Δ} G ( {x}_{k} , {I}_{k} )\end{matrix} \qquad ( 31 )$$

where we used the cubature rule presented above. The cubature points αᵢ are defined in (22). Then, by applying of the cubature rule once again, the cost function in (30) is approximated as follows:

$$\begin{matrix}{g}_{k} ( {θ}_{k} , {I}_{k} ) \approx {\int }_{{x}_{k}} 𝒩 ( {x}_{k} \text{:} {\hat{x}}_{k \vert k - 1} \cdot {P}_{k \vert k - 1} ) \\ {\int }_{{z}_{k}} 𝒩 ( {z}_{k} \text{:} h ( {x}_{k} ) , {R}_{k} ( {θ}_{k} ) ) \\ \{ D ( {x}_{k} , {z}_{k} , {I}_{k} , {θ}_{k} ) \} d {z}_{k} d {x}_{k} \\ \approx {\int }_{{x}_{k}} 𝒩 ( {x}_{k} \text{:} {\hat{x}}_{k \vert k - 1} , {P}_{k \vert k - 1} ) G ( {x}_{k} , {I}_{k} ) d {x}_{k} \\ \approx {\sum }_{i = 1}^{2 n} G ( {\hat{x}}_{k \vert k - 1} + {P}_{k \vert k - 1}^{1 / 2} {α}_{i} , {I}_{k} )\end{matrix} \qquad ( 32 )$$

where αᵢ are the cubature points defined in (22).

The cost function can be simplified to the covariance of the updated state. We show that by a simple assumption, the integrals of the cost function in (27) can be separated and therefore computed efficiently. Returning to this equation (27), consider the distribution p(zₖ|xₖ,Iₖ,θₖ). Observe that within the measurement prediction and update cycles of the CKF, the measurements are functions of θ solely through the noise covariance matrix R(θₖ defined in (15). In fact, the importance of the parameter θₖ is for the predicted measurement in (14) and otherwise irrelevant after the measurement is arrived to the receiver. Therefore, it is justified to approximate the distribution p(zₖ|xₖ,Iₖ,θk) by the predicted measurement distribution p(zₖ|Iₖ,θₖ). Thus from (25), we have:

$$\begin{matrix}{g}_{k} ( {θ}_{k} , {I}_{k} ) = {\int }_{{z}_{k}} {\int }_{{x}_{k}} p ( {z}_{k} \vert {x}_{k} , {I}_{k} , {θ}_{k} ) p ( {x}_{k} \vert {I}_{k} ) \{ {( {x}_{k} - {\hat{x}}_{k \vert k} )}^{T} Λ ( {x}_{k} - {\hat{x}}_{k \vert k} ) \} d {x}_{k} d {z}_{k} \approx {\int }_{{z}_{k}} {\int }_{{x}_{k}} p ( {z}_{k} \vert {I}_{k} , {θ}_{k} ) p ( {x}_{k} \vert {I}_{k} ) \{ {( {x}_{k} - {\hat{x}}_{k \vert k} )}^{T} Λ ( {x}_{k} - {\hat{x}}_{k \vert k} ) \} d {x}_{k} d {z}_{k} & ( 33 ) \\ = {\int }_{{z}_{k}} p ( {z}_{k} \vert {I}_{k} , {θ}_{k} ) {\int }_{{x}_{k}} p ( {x}_{k} \vert {I}_{k} ) \{ {( {x}_{k} - {\hat{x}}_{k \vert k} )}^{T} Λ ( {x}_{k} - {\hat{x}}_{k \vert k} ) \} d {x}_{k} d {z}_{k} & ( 34 ) \\ = {\int }_{{z}_{k}} p ( {z}_{k} \vert {I}_{k} , {θ}_{k} ) {\int }_{{x}_{k}} p ( {x}_{k} \vert {I}_{k} ) \{ Tr [ Λ ( {x}_{k} - {\hat{x}}_{k \vert k} ) {( {x}_{k} - {\hat{x}}_{k \vert k} )}^{T} ] \} d {x}_{k} d {z}_{k} & ( 35 ) \\ = Tr [ Λ {\int }_{{z}_{k}} p ( {z}_{k} \vert {I}_{k} , {θ}_{k} ) {\int }_{{x}_{k}} p ( {x}_{k} \vert {I}_{k} ) \{ ( {x}_{k} - {\hat{x}}_{k \vert k} ) {( {x}_{k} - {\hat{x}}_{k \vert k} )}^{T} \} d {x}_{k} d {z}_{k} ] & ( 36 )\end{matrix}$$

where in (35) we used the equality (x^{T}y=Tr[yx^{T}]) that holds for any two column vectors x and y. Observe that, for a state-space model with Gaussian distribution noises, the integrand of (36) is the expected updated state covariance matrix. Thus, we have:

$${g}_{k} ( {θ}_{k} , {I}_{k} ) \approx Tr [ Λ {\int }_{{z}_{k}} p ( {z}_{k} \vert {I}_{k} , {θ}_{k} ) {P}_{k \vert k} d {z}_{k} ] = Tr [ Λ {P}_{k \vert k} ] , \qquad ( 37 )$$

where P_{k|k} is defined in (20) which is independent of the measurement zₖ.

The objective function gₖ(•) can now be evaluated for each value of the parameter θₖ through computation of P_{k|k} defined previously in (20). Note that P_{k|k} is a function of θₖ through (15) which, in turn, defines the accuracy of the filter the predicted measurement zₖ.

We now generalize the method developed above for CWS to the case where the expected mean square error (MSE) is minimized with respect to parameters θₖ for a finite horizon ahead of the current time. This approach may be termed the Myopic Cognitive Waveform-Selection (M-CWS) method. Suppose, at time k=0, it is desired to optimize the parameters θⱼ j=0, . . . , L−1 to minimize all cost potentially incurred in a finite horizon of length L³. An admissible policy π is a sequence of mappings {μ⁰, . . . , μ^{k}}, where at sample k, the mapping μₖ determines the control input θₖ as a function of the vector information Iₖ:

μₖ(Iₖ)εΘₖ∀Iₖ, k=0, . . . , L−1 (38)

We would like to determine the best admissible policy as well as best values for the parameter θ that minimizes the cost function

$${J}_{π} = {{𝔼}_{{x}_{0} , {v}_{k} , {w}_{k}}}_{k = 1 , … , L - 1} \{ {c}_{L} ( {x}_{L} ) + {\sum }_{k = 0}^{L - 1} {c}_{k} [ {x}_{k} , {μ}_{k} ( {I}_{k} ) , {v}_{k} ] \} \qquad ( 39 )$$

subject to the system and measurement equations, respectively:

xₖ=f(xₖ₋₁)+vₖ (40)

zₖ=h(xₖ)+wₖ(μₖ(Iₖ)), k=1, . . . , L−1, (41)

where the expectation is with respect to all sources of uncertainty, including the initial state distribution, the state and the measurement noises. Here, the control input to the CWS module is defined by μₖ(Iₖ)=θₖεΘₖ where we assume that Θₖ is a nonempty subset of a control space Cₖε [symbol] . Two important essential differences between CWS and conventional control system (CCS) procedures need to be pointed out.

Firstly, in contrast to CCS, here the control input θₖ appears in the measurement equation and only implicitly (through the noise covariance matrix (15)). More importantly, in CWS, the control input is selected and applied to the system right before acquiring the measurement zₖ through the measurement equation. This is again different, compared to the CCS in which the control input at time k is decided upon using all information including the measurement zₖ. This is due to the fact that in conventional systems, the input is used to control the state evolution rather than to optimize the measurements as in the CWS case.

In particular, in CWS, the following steps occur sequentially: At any time k−1, the state is advanced to the time state xₖ (see (4)). Then, given a set of available information (zₖ₋₁, θₖ₋₁) the parameter θₖ is selected through the CWS procedure. The selected parameter θₖ is then used to measure the state variable zₖ by using (5).

Dynamic programming may also be used for the M-CWS method with a general cost function g(•). In the optimization problem described in (39), the state variable xₖ is hidden and only observable through the noisy measurement zₖ. This optimization can be converted (see D. P. Bertsekas, Dynamic Programming and Optimal Control. Belmont, Mass.: Athena Scientific, third ed., pp. 217-279, 2005 for details) so that it is based on an completely observable state evolution equation as follows. Observe that by the definition of the information vector, we have:

Iₖ₊₁=(Iₖ,zₖ,θₖ) k=1, 2, . . . , L−1 (42)

The set of equations (42) can be considered as a system evolution equation with a new state variable Iₖ. In the set of equations, the measurement zₖ can be viewed as a random disturbance that emerges after the measurement process. By assuming the new system evolution equation, it can be shown that the dynamic programming algorithm for solving the optimization problem of (39) can be written as follows:

$$\begin{matrix}{J}_{L - 1} ( {I}_{L - 1} ) = {inf}_{{θ}_{L - 1} ∈ {Θ}_{L - 1}} {g}_{L - 1} ( {I}_{L - 1} , {θ}_{L - 1} ) & ( 43 ) \\ \begin{matrix}{J}_{k} ( {I}_{k} ) = {inf}_{{θ}_{k} ∈ {Θ}_{k}} [ {g}_{k} ( {I}_{k} , {θ}_{k} ) + {E}_{{z}_{k} \vert {I}_{k} , {θ}_{k}} \{ {J}_{k + 1} ( {I}_{k + 1} ) \} ] \\ = {inf}_{{θ}_{k} ∈ {Θ}_{k}} [ {g}_{k} ( {I}_{k} , {θ}_{k} ) + {E}_{{z}_{k} \vert {I}_{k} , {θ}_{k}} \{ {J}_{k + 1} ( {I}_{k} , {z}_{k} , {θ}_{k} ) \} ]\end{matrix} & ( 44 )\end{matrix}$$

where we defined gₖ previously in (24) that is related to the cost function in (39) as follows:

gₖ(Iₖ,θₖ)=Eₓ_{ₖ}_{|I}_{ₖ}_{,θ}_{ₖ}{cₖ(xₖ,θₖ,vₖ)} (45)

It can be seen from (44) that for L=1 the dynamic programming method is simplified to the non-myopic case presented above.

The second term in (44) accounts for an expected cost at k+1, namely [symbol] _{|I}_{ₖ}_{,θ}_{ₖ}Jₖ₊₁(Iₖ₊₁), assuming that the measurement zₖ has been received at time k. Using the cubature rule discussed above, this expectation can be approximated as follows (Eqn. (46)):

$${E}_{{z}_{k} \vert {I}_{k} , {θ}_{k}} \{ {J}_{k + 1} ( {I}_{k} , {z}_{k} , {θ}_{k} ) \} = {\int }_{{z}_{k}} p ( {z}_{k} \vert {I}_{k} , {θ}_{k} ) \{ {J}_{k + 1} ( {I}_{k} , {z}_{k} , {θ}_{k} ) \} = {\int }_{{z}_{k}} 𝒩 ( {\hat{z}}_{k \vert k - 1} , {P}_{zz , k \vert k - 1} ) \{ {J}_{k + 1} ( {I}_{k} , {z}_{k} , {θ}_{k} ) \} \approx {\sum }_{i = 1}^{2 n} \{ {J}_{k + 1} ( {I}_{k} , ( {\hat{z}}_{k \vert k - 1} + {P}_{zz , k \vert k - 1}^{1 / 2} {α}_{i} ) , {θ}_{k} ) \}$$

The predicted measurement \hat{z}_{k|k-1} and the covariance of the predicted measurement P_{zz,k|k-1} are defined in (14) and (15), respectively. Here, n=2 is the dimension of the measurement zₖ and the cubature points αᵢ were defined in (22).

Dynamic programming may also be used for M-CWS with an approximate cost function as explained below. The dynamic programming method for optimization of the approximate cost function

gₖ(Iₖ,θₖ)=Tr[ΛP_{k|k}] (47)

assumes the form:

$$\begin{matrix}{J}_{L - 1} ( {I}_{L - 1} ) = {inf}_{{θ}_{L - 1} ∈ {Θ}_{L - 1}} Tr [ Λ {P}_{L - 1 \vert L - 1} ] & ( 48 ) \\ \begin{matrix}{J}_{k} ( {I}_{k} ) = {inf}_{{θ}_{k} ∈ {θ}_{k}} [ Tr [ Λ {P}_{L - 1 \vert L - 1} ] ) + {E}_{{z}_{k} \vert {I}_{k} , {θ}_{k}} \{ {J}_{k + 1} ( {I}_{k + 1} ) \} ] \\ = {inf}_{{θ}_{k} ∈ {θ}_{k}} [ Tr [ Λ {P}_{k \vert k} ] + {E}_{{z}_{k} \vert {I}_{k} , {θ}_{k}} \{ Tr [ Λ {P}_{k + 1 \vert k + 1} ] \} ] .\end{matrix} & ( 49 )\end{matrix}$$

where the state error covariance P_{k+1|k+1} is a function of the measurements x^{k}. In order, we evaluate the cost Jₖ(Iₖ),Jₖ(Iₖ), given Iₖ and, for each value required to evaluate P(k+1|k+1) for all the expected measurements, zₖ. The expectation in this equation can be computed using Monte-Carlo simulation:

$${E}_{{z}_{k} \vert {I}_{k} , {θ}_{k}} \{ Tr [ Λ {P}_{k + 1 \vert k + 1} ] \} = Tr [ Λ {E}_{{z}_{k} \vert {I}_{k} , {θ}_{k}} {P}_{k + 1 \vert k + 1} ( {z}_{k} ) ] \approx Tr [ Λ {\sum }_{p = 1}^{{N}_{z}} {P}_{k + 1 \vert k + 1} ( {z}_{p} ) ] , \qquad ( 50 )$$

where zₚ, p=1, . . . , N_{Z} are independent samples from distribution p(xₖ|Iₖ,θₖ).

Observe that the expectation term in (49) can also be written as

$$\begin{matrix}{E}_{{z}_{k} \vert {I}_{k} , {θ}_{k}} \{ Tr [ Λ {P}_{k + 1 \vert k + 1} ] \} = Tr [ Λ {E}_{{z}_{k} \vert {I}_{k} , {θ}_{k}} {P}_{k + 1 \vert k + 1} ( {z}_{k} ) ] & ( 51 ) \\ = Tr [ Λ {\int }_{{z}_{k}} p ( {z}_{k} \vert {I}_{k} , {θ}_{k} ) {P}_{k + 1 \vert k + 1} ( {z}_{k} ) ] & ( 52 ) \\ = Tr [ Λ {\int }_{{z}_{k}} 𝒩 ( z ; {\hat{z}}_{k \vert k - 1} , {P}_{zz , k \vert k - 1} ) {P}_{k + 1 \vert k + 1} ( {z}_{k} ) ] & ( 53 )\end{matrix}$$

where we substituted the predicted measurement distribution defined in (13). It can be seen that the integrand in (53) is in the form “gaussian×nonlinear function” that can be conveniently computed by the cubature rule, yielding

$${E}_{zk \vert {I}_{k} , {θ}_{k} \{ Tr [ Λ {P}_{k + 1 \vert k + 1} ] \} \approx Tr [ \frac{1}{2 n} Λ {\sum }_{i = 1}^{2 n} {P}_{k \vert k} ( {\hat{z}}_{k \vert k - 1} + {P}_{zz , k \vert k - 1}^{1 / 2} {α}_{i} ) ]} \qquad ( 54 )$$

where, in this case n=2 is the dimension of the measurement, P_{zz,k|k-1}^{1/2} is the square root of the covariance matrix P_{zz,k|k-1} and the cubature points αᵢ were defined in (22).

The above method was tested in a number of experiments, the results of which are provided below. The experimental results are simulated for an “X-band” radar with carrier frequency f_{c}=10.4 GHz. The radar transmitter is assumed to be equipped with a library of transmit waveforms, defined on a discrete two-dimensional grid over parameter space Θ:

λε[10⁻⁶,300⁻⁶]

bε[10e8,800e8]

with grid step-sizes:

δλ=10⁻⁶

δb=10⁸.

The sampling rate of the tracking radar is assumed to be Tₛ=1 sec. The simulations results are given for m=50 Monte-Carlo runs.

We model the returned pulse SNR for a target at distance r as:

$${η}_{r} = {( \frac{{r}_{0}}{{r}_{k}} )}^{4} {η}_{{r}_{0}}$$

where ηᵣ₀ is the SNR of the transmitted pulse at a reference distance r₀ and is typically set to be 0 dB at this distance. That is, at distance r₀, we assume that signal power is equal to noise power. Although, for a chosen r₀, the power of a transmitted pulse is fixed, the returned pulse SNR is dependent on the location of the target—when the distance between the target and the radar is below r₀, the returned pulse SNR is positive and negative otherwise.

In the experiments, we consider the tracking performance for three cases:
(1) Fixed-waveform tracking radar: The waveform used for the transmitter is randomly selected from the available library.
(2) Non-myopic cognitive waveform-selection (NM-CWS): In this case, the CWS algorithm selects the transmitted waveform that is non-myopic and only optimizes the performance measure.
(3) Myopic cognitive waveform-selection (M-CWS): In this case, the CWS is performed using a dynamic programming algorithm with horizon L=3.

The performance of the CTR is observed for two different and difficult scenarios, that of tracking a falling object and that of tracking a maneuvering target.

Tracking a falling object: Tracking ballistic targets is one of the most extensively studied applications considered by the aerospace engineering community. The goal of the tracking radar, in this case, is to is intercept and track the ballistic targets before they hit the ground. The flight of a ballistic target, from launch to impact, consists of three phases: the boost phase, the coast phase and the re-entry phase. Here we limit our focus to tracking a ballistic target on re-entry.

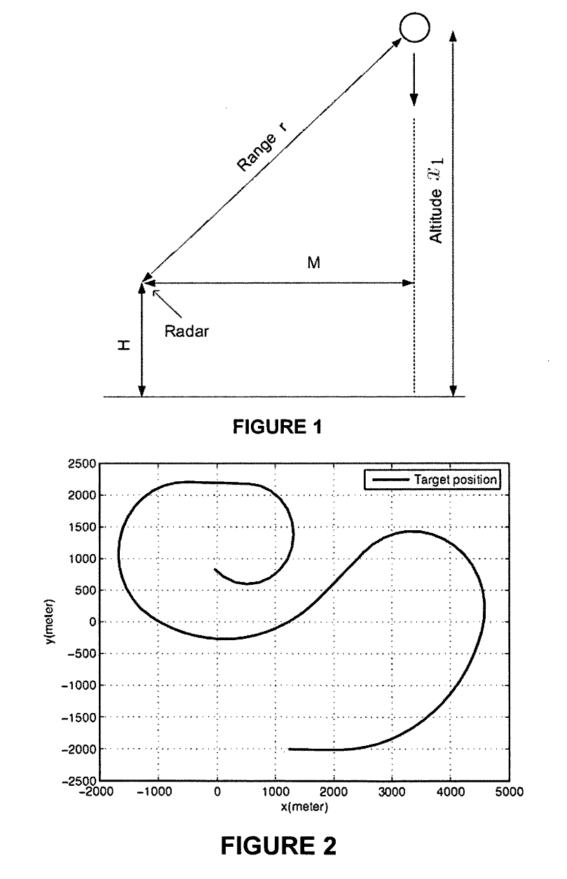

Reentry Scenario: When a ballistic target re-enters the Earth's atmosphere after having traveled a long distance, its speed is high and the remaining time to ground impact is relatively short. In the experiment, we consider a ballistic target falling vertically as shown in FIG. 1. In the re-entry phase, two types of forces are in effect. The most dominant force is drag, which is a function of speed and has a substantial nonlinear variation in altitude; the second force is due to gravity, which accelerates the target toward the center of the earth. This tracking problem is highly difficult because the target's dynamics change rapidly. Under the influence of drag and gravity acting on the target, the following differential equation governs its motion:

$${\dot{x}}_{1} = - {x}_{2}$$

$${\dot{x}}_{2} = \underbrace{\frac{- ρ ( {x}_{1} ) \cdot g \cdot {x}_{2}^{2}}{2 {x}_{3}}}_{drag} + g$$

$${\dot{x}}_{3} = 0 ,$$

where
x₁ is altitude;
x₂ is velocity;
x₃ is the constant ballistic coefficient that depends on the target's mass, shape, cross-sectional area, and air density;
μ(x₁) is air density and modeled as an exponentially decaying function of altitude x₁:

μ(x₁)=ρ₀exp(−γx₁),

where the proportionality constant ρ₀=1.754 and γ=1.49×10⁻⁴; and
g is gravity (g=9.8 ms⁻²).

By choosing the state vector x=[x₁ x₂ x₃], the process equation in continuous time t can be expressed by

\dot{x}ₜ=g(xₜ),

Using the Euler approximation with a small integration step δ, we write

$$\begin{matrix}{x}_{k + 1} = [ {x}_{k} + δ g ( {x}_{k} ) ] \\ = f ( {x}_{k} ) .\end{matrix} \qquad ( 55 )$$

In order to account for imperfections in the process model (e.g., lift force, small variations in the ballistic coefficient, and spinning motion), we add zero-mean Gaussian process noise, obtaining the new process equation:

xₖ₊₁=f(xₖ)+wₖ, (56)
where
   f(xₖ)=φxₖ−G[D(xₖ)−g] with matrices

$$Φ = ( \begin{matrix}1 & - δ & 0 \\ 0 & 1 & 0 \\ 0 & 0 & 1\end{matrix} )$$

$$G = {[ \begin{matrix}0 & δ & 0\end{matrix} ]}^{T}$$

and drag

$$D ( {x}_{k} ) = \frac{ρ ( {x}_{k} [ 1 ] ) \cdot g \cdot {x}_{k}^{2} [ 2 ]}{2 {x}_{k} [ 3 ]} .$$

We assume that the process noise is zero-mean Gaussian with covariance matrix

$$Q = ( \begin{matrix}{q}_{1} \frac{{δ}^{3}}{3} & {q}_{1} \frac{{δ}^{2}}{2} & 0 \\ {q}_{1} \frac{{δ}^{2}}{2} & {q}_{1} δ & 0 \\ 0 & 0 & {q}_{2} δ\end{matrix} )$$

where the parameters q₁ and q₂ control the amount of process noise in target dynamics and ballistic coefficient, respectively.

A radar is assumed to be located at (0,H), and equipped to measure the range r and the range-rate \dot{r} at a measurement time interval of T. Hence, the measurement equation is given by

$${r}_{k} = \sqrt{{M}^{2} + {( {x}_{k} [ 1 ] - H )}^{2}} + {v}_{k} [ 1 ]$$

$${\dot{r}}_{k} = \frac{{x}_{k} [ 2 ] ( {x}_{1 , k} - H )}{\sqrt{{M}^{2} + {( {x}_{k} [ 1 ] - H )}^{2}}} + {v}_{k} [ 2 ]$$

where the measurement noise vₖ˜ [symbol] (0,Rₖ); and M is the horizontal distance (see FIG. 1).

For our experimental simulations, we consider the following parameter values:

H=30 m

M=30 km

q₁=0.01

q₂=0.01

δ=1 s

The true initial state is assumed to be:

x₀=[61 km 3048 m/s 19161]^{T}

Also, the initial state estimate and its covariance were assumed to be:

\hat{x}_{0|0}=[62 km 3400 m/s 19000]^{T}

P_{0|0}=diag([10⁶ 10⁴ 10⁴]).

The other scenario against which the CTR was evaluated is the Tracking Maneuvering Target scenario.

Tracking Maneuvering Target: A maneuvering target is one of the most popular targets in radar tracking society. Taking the air traffic control (ATC) as an example, the aircraft performs maneuvering behaviors in circumstances of turning or climbing/descending [13]. Generally speaking, the target maneuvers in three-dimensional space. The horizontal and vertical motion can, nevertheless, be decoupled. We will consider the maneuvering behavior of the target in the horizontal space for simplicity of discussion. The performance of the traditional radar will degrade to track a target which turns frequently.

Consider the scenario of tracking aircraft performed at an air show (see FIG. 2). The turn of the aircraft follows the nearly coordinated turn model, given by:

$${x}_{k + 1} = [ \begin{matrix}1 & \frac{sin ( {Ω}_{k} ) T}{{Ω}_{k}} & 0 & - \frac{1 - cos ( {Ω}_{k} ) T}{{Ω}_{k}} \\ 0 & cos ( {Ω}_{k} ) T & 0 & - sin ( {Ω}_{k} ) T \\ 0 & \frac{1 - cos ( {Ω}_{k} ) T}{{Ω}_{k}} & 1 & \frac{sin ( {Ω}_{k} ) T}{{Ω}_{k}} \\ 0 & sin ( {Ω}_{k} ) T & 0 & cos ( {Ω}_{k} ) T\end{matrix} ] {x}_{k} + [ \begin{matrix}\frac{1}{2} {T}^{2} & 0 \\ T & 0 \\ 0 & \frac{1}{2} {T}^{2} \\ 0 & T\end{matrix} ] {v}_{k} ;$$

where Ωₖ is the turn rate at time k. The vector x is the state of the target, defined as

x=[x \dot{x} y \dot{y}]

with x and y denoting the coordinates, and \dot{x} and \dot{y} denoting the respective velocities. Assuming that only the position measurements are available, we can observe the target as follows:

$${z}_{k} = [ \begin{matrix}1 & 0 & 0 & 0 \\ 0 & 1 & 0 & 0\end{matrix} ] {x}_{k} + {w}_{k} ( {θ}_{k} )$$

The location of the radar is defined as the origin. The initial state x₀=[1000,220,−2000,0]^{T}. We define a time history vector t and turn rate vector Ω to denote the behavior of the target. The time history vector and turn rate history vector are respectively given by:

t=[5, 20, 35, 40, 55, 70, 75, 80]

Ω=[0°, 5°, 10°, 0°, −5°, −10°, 0°, −15°].

Throughout the experiments, we use two performance measures:

RMSE: The root mean-square error (RMSE) for the i-th state component at time k is defined by

$${ε}_{k} [ i ] = \sqrt{\frac{1}{m} {\sum }_{n = 1}^{m} {( {x}_{k}^{( n )} [ i ] - {\hat{x}}_{k \vert k}^{( n )} [ i ] )}^{2}} ,$$

where m is the total number of Monte Carlo simulation runs. Each trajectory is simulated for 30 time steps and a total of m=50 independent Monte Carlo runs was made.

Accumulative RMSE (ARMSE): The ARMSE in the i-th state component for the reference distance r₀ is defined by:

$${ε}_{{r}_{0}} [ i ] = \sqrt{\frac{1}{mK} {\sum }_{n = 1}^{m} {\sum }_{k = 1}^{K} {( {x}_{k}^{( n )} [ i ] - {\hat{x}}_{k \vert k}^{( n )} [ i ] )}^{2}} ,$$

where K is the total number of time-steps per trajectory; m is the total number of Monte Carlo simulation runs. Each trajectory is simulated for 30 time-steps and a total of m=50 independent Monte Carlo runs was made.

For the two above-mentioned scenarios, a number of experimental observations were made.

1) The effect of SNR on tracking performance: In this experiment, we compare the performance of the CTR that adaptively modifies its waveform with the conventional radar that uses a fixed waveform as r₀ varies. In our experiment, we varied r₀ from 10 to 100 km.

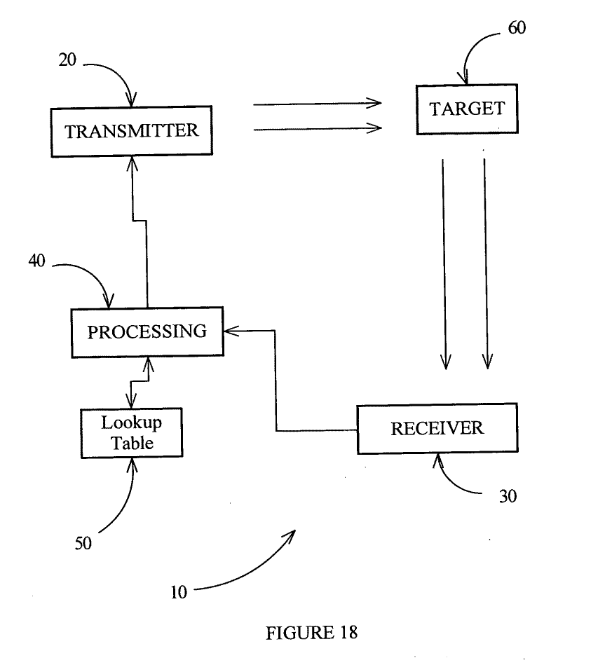

Falling object: FIGS. 18, 19 and 20 show how the ARMSE in altitude, velocity and ballistic coefficient vary with r₀. As expected, the ARMSE of the conventional tracking radar decreases as r₀ increases; whereas the CTR appears to be less sensitive to the choice of r₀ (or the power of the transmitter) except in tracking the ballistic coefficient. Though the CTR outperforms the conventional radar, the trend in tracking the ballistic coefficient appears unpredictable. The reason for this can be attributed to the dependency of this coefficient on the environmental parameters, e.g., air density.

Maneuvering target: FIGS. 21 and 22 depict the ARMSE in position and velocity as r₀ varies. As can be seen from these figures, the CTR consistently outperforms the conventional radar for all r₀.

2) The effect of transmitted signal bandwidth of tracking performance: In this experiment, we study the impact of bandwidth constraints on the performance of our method. The bandwidth is defined as the product of chirp rate and envelope of the pulse, that is:

bω=b*λ

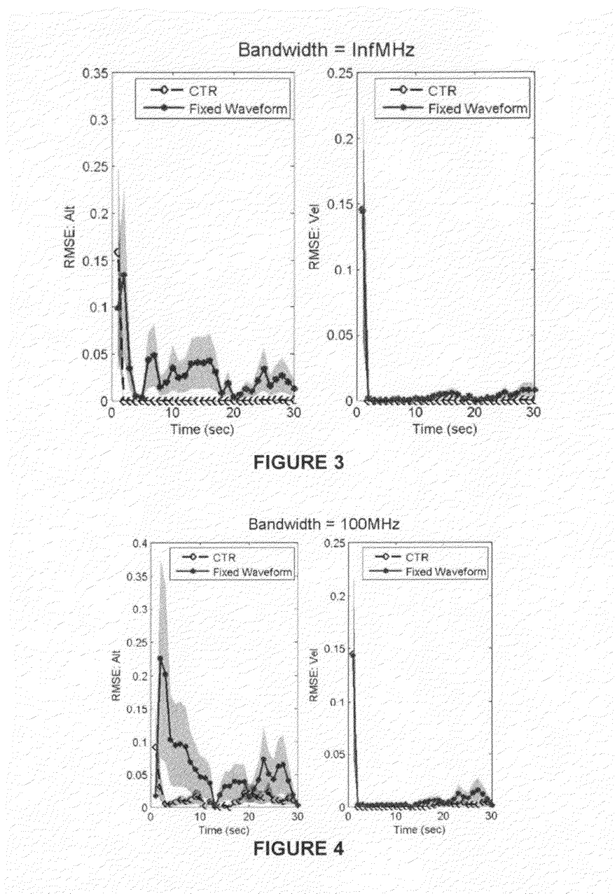

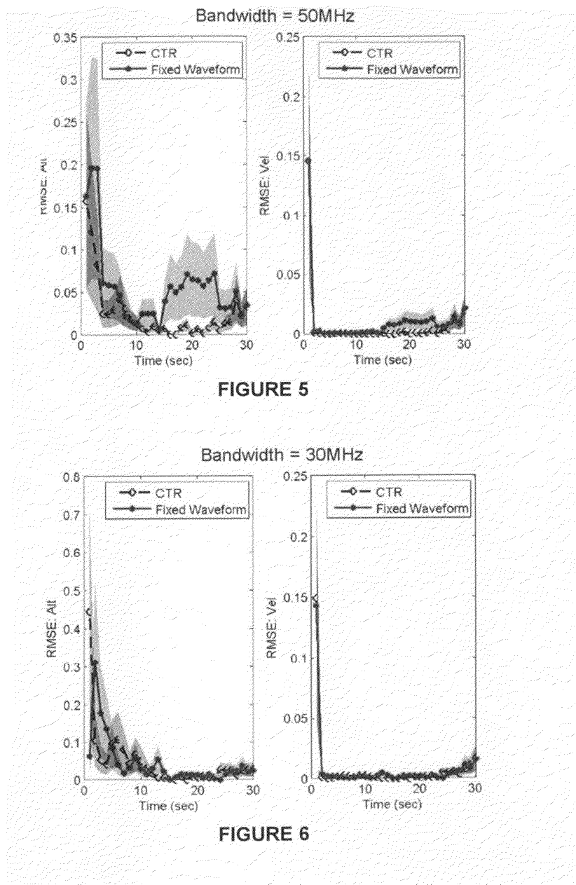

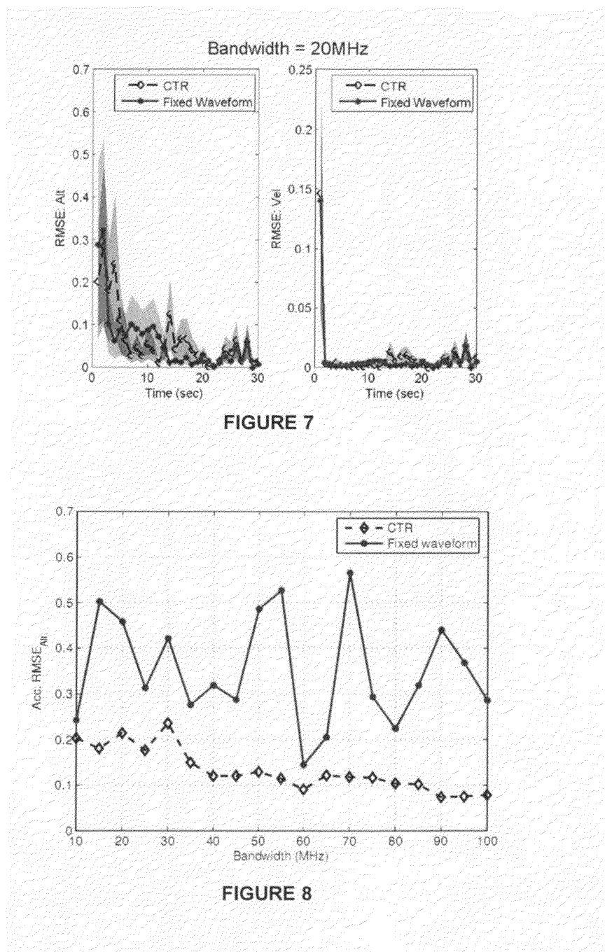

We varied bω from ∞ to 20 MHz. The results of both the tracking curve and RMSE in altitude and velocity are plotted in FIGS. 3, 4, 5, 6 and 7. The shaded regions around the curve plot the error bar of the RMSE. We define the half standard deviation as the error. The standard deviation is the square-rooted variance, which is frequently addressed as the spread in the literature. It is defined by:

$$σ = \vert \frac{1}{n} {\sum }_{i = 1}^{n} {( {x}_{i} - μ )}^{2} \vert$$

$$where$$

$$μ = \frac{1}{n} {\sum }_{i = 1}^{n}$$

is the mean.

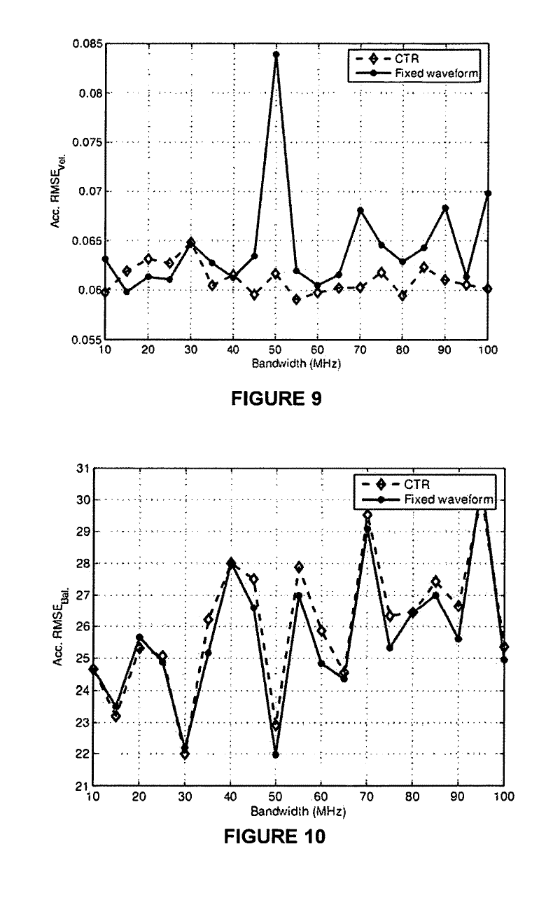

Falling object: Following the techniques we have used in conducting the effect of SNR on radar performance, we also plot the ARMSE in distance versus bandwidth in FIGS. 8, 9 and 10. It is obvious that the CTR is less sensitive to the constraints of the bandwidth than a conventional radar with fixed waveform.

Additionally, we could see from the results that the CTR outperforms conventional radar for all occasions. The RMSE converges to small values within a short time, whereas the conventional radar takes a longer time to converge to a small value of RMSE.

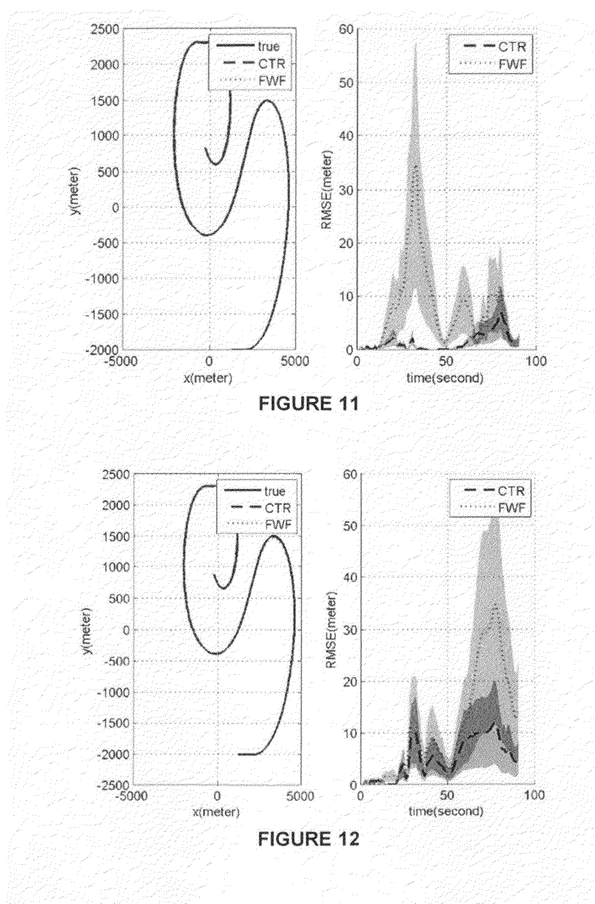

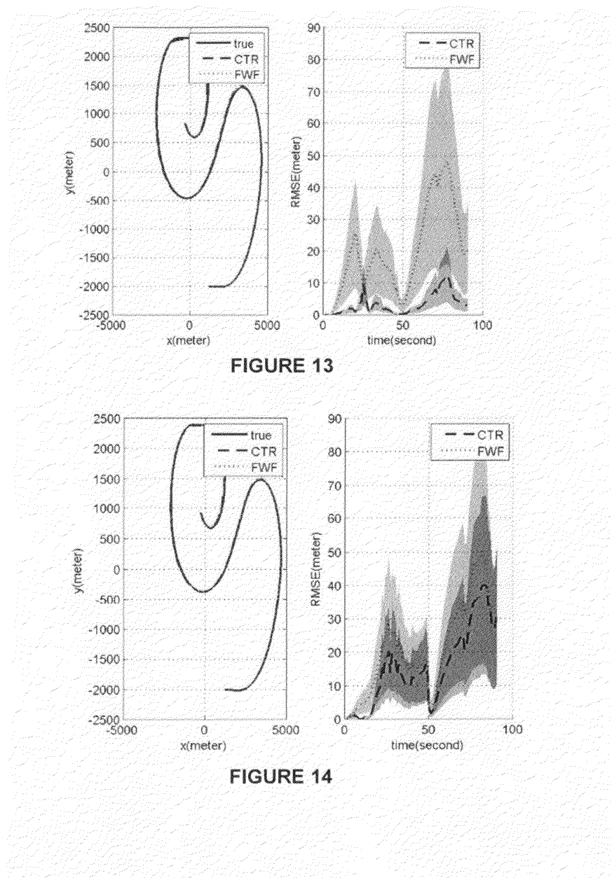

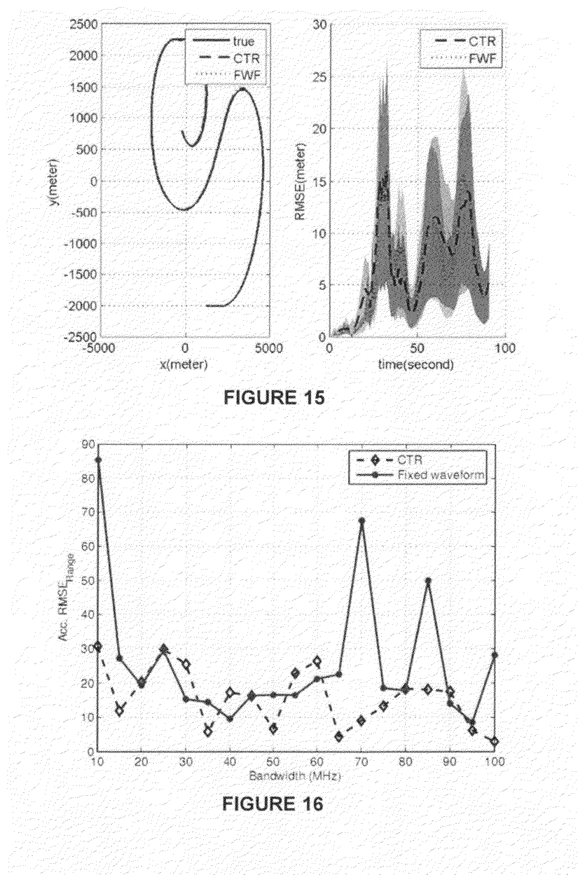

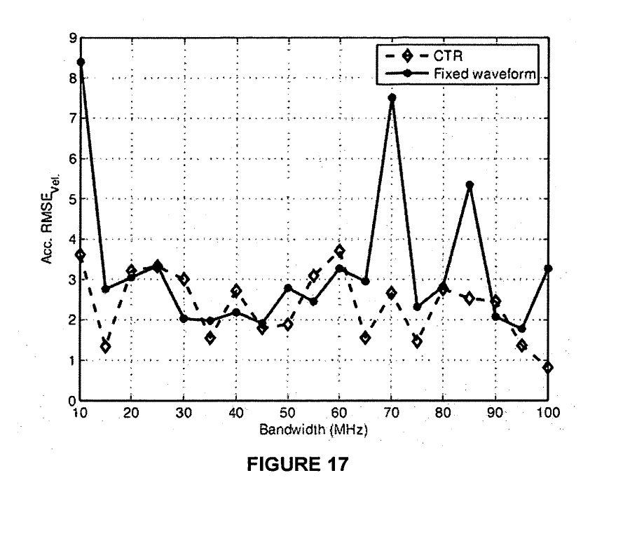

Maneuvering target: We plot the RMSE for the range without bandwidth constraint in FIG. 11. The RMSEs for bω=100, 50, 30, 20 are also plotted in FIGS. 12, 13, 14, and 15, respectively. We again observe that the CTR outperforms the conventional radar with fixed waveform for most of the cases. It is also to be noted that, as the bandwidth decreases, the margin between CTR and conventional radar is also decreased. One obvious reason for this is that the use of low bandwidth actually restricts the number of radar waveforms. We also show the relationship between bandwidth and accumulated RMSE in FIGS. 16 and 17, where we see that the sensitivity of the CTR to changes in bandwidth is lower than that of the conventional radar.

The system according one aspect of the invention is illustrated in FIG. 18. The system 10 has a radar transmitter 20, a radar receiver 30, a processing subsystem 40 which communicates with a lookup table 50. The transmitter 20 transmits electromagnetic radiation to a target 60. The radiation reflects off the target 60 to be received by the receiver 30. The received radiation is assessed and the results of the assessment are sent to the processing subsystem 40. The processing subsystem then determines, based on the received data, what parameters and/or waveforms should be used to illuminate the target. The waveforms and/or parameters may be stored in a lookup table 50 as well as other data which would assist the processing subsystem in determining which parameters would provide the best results. Once this determination has been made, the parameters/waveforms are then sent to the transmitter. The transmitter then transmits radiation using the parameters/waveforms it has received from the processing subsystem.

It should be noted that, to assist the processing subsystem in its decision, it may iterate through or simulate various possible scenarios using various parameters and waveforms in the lookup table to determine, given the measurements received from the receiver and the predicted state of the target, which options provide a “best” result or which options provide results which best conform to predetermined criteria.

Regarding the cubature Kalman filter, it is clear from the above discussion that the CKF is used in computing integrals whose integrands are all of the form nonlinear function×Gaussian density. The CKF can be derived by considering an integral of the form

I(f)=∫ [symbol] f(x)exp(−x^{T}x)dx (57)

defined in the Cartesian coordinate system. To compute the above integral numerically we take the following two steps:

(i) We transform it into a more familiar spherical-radial integration form (ii) Subsequently, we propose a third-degree spherical-radial rule.

In the spherical-radial transformation, the key step is a change of variable from the Cartesian vector xεRⁿ to a radius r and direction vector y as follows: Let x=ry with y^{T}y=1, so that x^{T}x=r² for rε[0,∞). Then the integral (57) can be rewritten in a spherical-radial coordinate system as

I(f)=∫₀^{∞}∫_{U}_{ₙ}f(ry)rⁿ⁻¹exp(−r²)dσ(y)dr (58)

where Uₙ is the surface of the sphere defined by Uₙ={yε [symbol] ⁿ|y^{T}y=1} and σ(.) is the spherical surface measure or the area element on Uₙ. We may thus write the radial integral

I=∫₀^{∞}S(r)rⁿ⁻¹exp(−r²)dr (59)

where S(r) is defined by the spherical integral with the unit weighting function w(y)=1:

S(r)=∫_{U}_{ₙ}f(ry)dσ(y) (60)

The spherical and the radial integrals are numerically computed by the spherical cubature rule (see below) and the Gaussian quadrature rule (see below), respectively. Before proceeding further, we introduce a number of notations and definitions when constructing such rules as follows:
A cubature rule is said to be fully symmetric if the following two conditions hold:

1) xε [symbol] implies yε [symbol] , where y is any point obtainable from x by permutations and/or sign changes of the coordinates of x.

2) w(x)=w(y) on the region [symbol] That is, all points in the fully symmetric set yield the same weight value.

For example, in the one-dimensional space, a point xε [symbol] in the fully symmetric set implies that (−x)ε [symbol] and w(x)=w(−x).
In a fully symmetric region, we call a point u as a generator if u=(u₁, u₂, . . . , uᵣ, 0, . . . 0)ε [symbol] where uᵢ≧uᵢ₊₁>0, i=1, 2, . . . (r−1). The new u should not be confused with the control input u.
For brevity, we suppress (n−r) zero coordinates and use the notation [u₁, u₂, . . . uᵣ] to represent a complete fully symmetric set of points that can be obtained by permutating and changing the sign of the generator u in all possible ways. Of course, the complete set entails

$$\frac{{2}^{r} n !}{( n - r ) !}$$

points when {uᵢ} are all distinct. For example, [1]ε [symbol] represents the following set of points:

{(₀¹),(₁⁰),(₀¹),(₋₁⁰)}.

where the generator is (₀¹).
We use [u₁, u₂, . . . uᵣ]ᵢ to denote the i-th point from the set [u₁, u₂, . . . uᵣ].

We first postulate a third-degree spherical cubature rule that takes the simplest structure due to the invariant theory:

∫_{U}_{ₙ}f(y)dσ(y)≈wΣᵢ₌₁²ⁿf[u]ᵢ. (61)

The point set due to [u] is invariant under permutations and sign changes. For the above choice of the rule (61), the monomials {y₁^{d}^{₁} y₂^{d}^{₂} y₃^{d}^{₃} . . . yₙ^{d}^{ₙ}} with Σᵢ₌₁ⁿdᵢ being an odd integer, are integrated exactly. In order that this rule is exact for all monomials of degree up to three, it remains to require that the rule be exact for all monomials for which Σᵢ₌₁ⁿdᵢ=0, 2. Equivalently, to find the unknown parameters u and ω, it suffices to consider monomials f(y)=1, and f(y)=y₁² due to the fully symmetric cubature rule:

$$\begin{matrix}f ( y ) = 1 \text{:} 2 nw = {\int }_{{U}_{n}} d σ ( y ) = {A}_{n} & ( 62 ) \\ f ( y ) = {y}_{1}^{2} \text{:} 2 {wu}^{2} = {\int }_{{U}_{n}} {y}_{1}^{2} d σ ( y ) = \frac{{A}_{n}}{n} & ( 63 )\end{matrix}$$

where the surface area of the unit sphere

$${A}_{n} = \frac{2 \sqrt{{π}^{n}}}{Γ ( \frac{n}{2} )}$$

with Γ(n)=∫₀^{∞}xⁿ⁻¹exp(−x)dx. Solving (62)-(63) yields

$$ω = \frac{An}{2 n} ,$$

and u²=1. Hence, the cubature points are located at the intersection of the unit area and its axes.

The next step in the derivation is the proposal of a Gaussian quadrature for the radial integration. The Gaussian quadrature is known to be the most efficient numerical method to compute a one-dimensional integration. An m-point Gaussian quadrature is exact up to polynomials of degree (2m−1) and constructed as follows:

∫ₐ^{b}f(x)w(x)dx≈Σᵢ₌₁^{m}wᵢf(xᵢ), (64)

where w(x) is a known weighting function and non-negative on the interval [a, b]; the points {xᵢ} and the associated weights {ωᵢ} are unknowns to be determined uniquely. In our case, a comparison of (59) and (64) yields the weighting function and the interval to be w(x)=xⁿ⁻¹exp(−x²) and [0,∞) respectively. To transform this integral into an integral for which the solution is familiar, we make another change of variable via t=x² yielding

$${\int }_{0}^{∞} f ( x ) {x}^{n - 1} exp ( - {x}^{2} ) d x = \frac{1}{2} {\int }_{0}^{∞} \tilde{f} ( t ) {t}^{( \frac{n}{2} - 1 )} \times exp ( - t ) d t ; \qquad ( 65 )$$

where \tilde{f}(t)=(f\sqrt{t}). The integral on the right-hand side of (65) is now in the form of the well-known generalized Gauss-Laguerre formula. The points and weights for the generalized Gauss-Laguerre quadrature are readily obtained as discussed elsewhere. A first-degree Gauss-Laguerre rule is exact for \tilde{f}(t)=1,t. Equivalently, the rule is exact for f(x)=1, x²; it is not exact for odd degree polynomials such as f(x)=x,x³. Fortunately, when the radial-rule is combined with the spherical rule to compute the integral (57), the (combined) spherical-radial rule vanishes for all odd-degree polynomials; the reason is that the spherical rule vanishes by symmetry for any odd-degree polynomial (see Eqn. (58)). Hence, the spherical-radial rule for (57) is exact for all odd degrees. Following this argument, for a spherical-radial rule to be exact for all third-degree polynomials in xε [symbol] it suffices to consider the first-degree generalized Gauss-Laguerre rule entailing a single point and weight. We may thus write

∫₀^{∞}f(x)xⁿ⁻¹exp(−x²)dx≈ω₁f(x₁) (66)

where the point x₁ is chosen to be the square-root of the root of the first-order generalized Laguerre polynomial, which is orthogonal with respect to the modified weighting function

$${x}^{( \frac{n}{2} - 1 )} exp ( - x ) ;$$

subsequently, we find ω₁ by solving the zeroth-order moment equation appropriately. In this case, we have

$${ω}_{1} = \frac{Γ ( \frac{n}{2} )}{2} , \\ and$$

$${x}_{1} = \sqrt{\frac{n}{2}} .$$

A detailed account of computing the points and weights of a Gaussian quadrature with the classical and nonclassical weighting function is presented in W. H. Press, and S. A. Teukolsky, “Orthogonal polynomials and Gaussian quadrature with nonclassical weighting functions,” Computers in Physics, pp. 423-426, July/August 1990.

One result from the above allows us to combine the spherical and radial rule obtained separately. This result may be presented as a theorem:

Theorem: Let the radial integral be computed numerically by the mᵣ-point Gaussian quadrature rule

$${\int }_{0}^{∞} f ( r ) {r}^{n - 1} exp ( - {r}^{2} ) d r = {\sum }_{i = 1}^{{m}_{r}} {a}_{i} f ( {r}_{i} )$$

Let the spherical integral be computed numerically by the mₛ-point spherical rule

∫_{U}_{ₙ}f(rs)dσ(s)=Σⱼ₌₁^{m}^{ₛ}bⱼf(rsⱼ)

Then, an (mₛ×mᵣ)-point spherical-radial cubature rule is given by

$${\int }_{{ℝ}^{n}} f ( x ) exp ( - {x}^{T} x ) d x \approx {\sum }_{j = 1}^{{m}_{s}} {\sum }_{i = 1}^{{m}_{r}} {a}_{i} {b}_{j} f ( {r}_{i} {s}_{j} ) \qquad ( 67 )$$

The proof of the above theorem is as follows:

Proof: Because cubature rules are devised to be exact for a subspace of monomials of some degree, we consider an integrand of the form

f(x)=x₁^{d}^{₁}x₂^{d}^{₂} . . . xₙ^{d}^{ₙ}

where {dᵢ} are some positive integers. Hence, we write the integral of interest

I(f)=∫ [symbol] x₁^{d}^{₁}x₂^{d}^{₂} . . . xₙ^{d}^{ₙ}exp(−x^{T}x)dx

For the moment, we assume the above integrand to be a monomial of degree d exactly; that is, Σᵢⁿdi=d. Making the change of variable as described above, we get

I(f)=∫₀^{∞}∫_{U}_{ₙ}(ry₁)^{d}^{₁}(ry₂)^{d}^{₂} . . . (ryₙ)^{d}^{ₙ}^{,n-1}×exp(−r²)dσ(y)dr

Decomposing the above integration into the radial and spherical integrals yields

I(f)=r^{n+d-1}exp(−r²)dr∫_{U}_{ₙ}y₁^{d}^{₁}y₂^{d}^{₂} . . . yₙ^{d}^{ₙ}dσ(y)

Applying numerical rules appropriately, we have

$$\begin{matrix}I ( f ) \approx ( {\sum }_{i = 1}^{{m}_{r}} {a}_{i} {r}_{i}^{d} ) ( {\sum }_{j = 1}^{{m}_{s}} {b}_{j} {s}_{j 1}^{d 1} {s}_{j 2}^{d 2} … {s}_{j n}^{d n} ) \\ = {\sum }_{i = 1}^{{m}_{r}} {\sum }_{j = 1}^{{m}_{s}} {a}_{i} {{b}_{j} ( {r}_{i} {s}_{j 1} )}^{d 1} {( {r}_{i} {s}_{j 2} )}^{d 2} … {( {r}_{i} {s}_{j n} )}^{d n}\end{matrix}$$

as desired. As we may extend the above results for monomials of degree less than d, the theorem holds for any arbitrary integrand that can be written as a linear combination of monomials of degree up to d.

Another result allows us to extend the spherical-radial rule for a Gaussian weighted integral. Again, this may be presented as a theorem:

Theorem: Let the weighting functions w₁(x) and w₂(x) be w₁(x)=exp(−x^{T}x) and w₂(x)= [symbol] (x:μ,Σ)). Then for every square matrix \sqrt{Σ} such that \sqrt{Σ}\sqrt{Σ}^{T}=Σ, we have

$${\int }_{{ℝ}^{n}} f ( x ) {w}_{2} ( x ) d x = \frac{1}{\sqrt{{π}^{n}}} {\int }_{{ℝ}^{n}} f ( \sqrt{2 Σ} x + μ \times {w}_{1} ( x ) d x . \qquad ( 68 )$$

The above may be proved as follows:

Proof: Consider the left-hand side of (68). Because Σ is a positive definite matrix, we factorize Σ to be \sqrt{Σ}\sqrt{Σ}^{T}.

Making a change of variable via x=\sqrt{2Σ}y+μ, we get

$$\begin{matrix}{\int }_{{ℝ}^{n}} f ( x ) N ( x ; μ , Σ ) d x = {\int }_{{ℝ}^{n}} f ( \sqrt{2 Σ} y + μ ) \frac{1}{\sqrt{2 πΣ \vert}} \times exp ( - {y}^{T} y ) \sqrt{2 Σ \vert d y} \\ = \frac{1}{\sqrt{{π}^{n}}} {\int }_{{ℝ}^{n}} f ( \sqrt{2 Σ} y + μ ) {w}_{1} ( y ) d y \\ = \frac{1}{\sqrt{{π}^{n}}} {\int }_{{ℝ}^{n}} f ( \sqrt{2 Σ} x + μ ) {w}_{1} ( x ) d x\end{matrix}$$

which proves the theorem.

For the third-degree spherical-radial rule, mᵣ=1 and mₛ=2n. Hence, it entails a total of 2n cubature points. Using the above theorems, we extend this third-degree spherical-radial rule to compute a standard Gaussian weighted integral as follows:

$${I}_{N} ( f ) {\int }_{{ℝ}^{n}} f ( x ) N ( x ; 0 , I ) d x \approx {\sum }_{i = 1}^{m} {w}_{i} f ( {ξ}_{i} )$$

$$where$$

$${ξ}_{i} = \sqrt{{\frac{m}{2} [ 1 ]}_{i}}$$

$${w}_{i} = \frac{1}{m} , i = 1 , 2 , … m = 2 n$$

We use the cubature-point set {ξᵢ, ωᵢ} to numerically compute integrals in the predictive density and the error covariance for the time update in the Bayesian filter as well as the filter likelihood density and the predicted measurement for the measurement update. We therefore obtain the CKF method, details of which are presented below. Note that the above cubature-point set is now defined in the Cartesian coordinate system.

The CKF method for dealing with Bayesian filters may therefore be seen as a discrete number of steps:

### Time Update:

1) Assume at time k that the posterior density function p(xₖ₋₁|Dₖ₋₁)= [symbol] (\hat{x}_{k-1|k-1},P_{k-1|k-1}) is known. Factorize

P_{k-1|k-1}=S_{k-1|k-1}S_{k-1|k-1}^{T}
2) Evaluate the cubature points (i=1, 2, . . . , m)

X_{i,k-1|k-1}=S_{k-1|k-1}ξᵢ+\hat{x}_{k-1|k-1}
where m=2ₙ_{ₓ}.
3) Evaluate the propagated cubature points (i=1, 2, . . . , m)

X_{i,k|k-1}*=f(X_{i,k-1|k-1},uₖ₋₁)
4) Estimate the predicted state

$${\hat{x}}_{k \vert k - 1} = \frac{1}{m} {\sum }_{i = 1}^{m} {X}_{i , k \vert k - 1}^{*}$$

5) Estimate the predicted error covariance

$${P}_{k \vert k - 1} = \frac{1}{m} {\sum }_{i = 1}^{m} {X}_{i , k \vert k - 1}^{*} {X}_{i , k \vert k - 1}^{* T} - {\hat{x}}_{k \vert k - 1} {\hat{x}}_{k \vert k - 1}^{T} + {Q}_{k - 1}$$

### Measurement Update:

1) Factorize

P_{k|k-1}=S_{k|k-1}S_{k|k-1}^{T}
2) Evaluate the cubature points (i=1, 2, . . . , m)

X_{i,k|k-1}=S_{k|k-1}ξᵢ+\hat{x}_{k|k-1}
3) Evaluate the propagated cubature points (i=1, 2, . . . , m)

Z_{i,k|k-1}=h(X_{i,k|k-1},uₖ)
4) Estimate the predicted measurement

$${\hat{z}}_{k \vert k - 1} = \frac{1}{m} {\sum }_{i = 1}^{m} {z}_{i , k \vert k - 1}$$

5) Estimate the innovation covariance matrix

$${P}_{zz , k \vert k - 1} = \frac{1}{m} {\sum }_{i = 1}^{m} {z}_{i , k \vert k - 1} {Z}_{i , k \vert k - 1}^{T} - {\hat{z}}_{k \vert k - 1} {\hat{z}}_{k \vert k - 1}^{T} + {R}_{k} ,$$

6) Estimate the cross-covariance matrix

$${P}_{xz , k \vert k - 1} = {\sum }_{i = 1}^{m} {w}_{i} {X}_{i , k \vert k - 1} {Z}_{i , k \vert - 1}^{T} - {\hat{x}}_{k \vert k - 1} {\hat{z}}_{k \vert k - 1}^{T}$$

7) Estimate the Kalman gain

Wₖ=P_{xz,k|k-1}P_{zz,k|k-1}⁻¹
8) Estimate the update state

\hat{x}_{k|k}=\hat{x}_{k|k-1}+Wₖ(zₖ−\hat{z}_{k|k-1})
9) Estimate the corresponding error covariance

P_{k|k}=P_{k|k-1}−WₖP_{zz,k|k-1}Wₖ^{T}

The above CKF method may be implemented in software or in hardware.

It should be noted that any useful data processing means may be used with the invention. As such, ASICs, general purpose CPUs, and other data processing devices may be used, either as dedicated processors for the calculations or as general purpose processors for a device incorporating the invention. The invention may be used to enhance currently existing radar control/processing hardware or software.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for operating a radar system for tracking a target, the radar system having a transmitter and a receiver, the method comprising:
a) determining an immediately preceding state of said target;
b) based on said immediately preceding state, predicting an expected state of said target;
c) based on said expected state of said target, determining parameters for use in illuminating said target;
d) using said transmitter to illuminate said target based on said parameters;
e) receiving radiation reflected from said target;
f) determining a current state of said target based on radiation received in step e)
g) using said current state as said immediately preceding state, repeating steps b)-g).

2. A method according to claim 1 wherein said parameters include which waveforms are to be used in illuminating said target.

3. A method according to claim 2 wherein said waveforms are selected from a predetermined table of waveforms.

4. A method according to claim 1 wherein step b) is accomplished using cubature Kalman filters.

5. A method according to claim 1 further including minimizing an error between said predicted state of said target and a measured state of, said target as determined from said radiation reflected from said target.

6. A system for iteratively tracking a target, the system comprising:
a transmitter for transmitting electromagnetic radiation to said target;
a receiver for receiving reflected radiation from said target;
processing means for receiving data related to said reflected radiation received by said receiver, said processing means determining parameters to be used by said transmitter when illuminating said target by transmitting said electromagnetic radiation;
wherein
said transmitter receives said parameters from said processing means, said parameters being determined by said processing means based on a predicted state of said target;
said processing means determines said predicted state based on an immediately preceding state of said target as derived from said reflected radiation received by said receiver.

7. A system according to claim 6 wherein said processing means determines which waveforms are to be used by said transmitter in transmitting said electromagnetic radiation to said target, said processing means determining said waveforms based on said predicted state of said target.

8. A system according to claim 7 further including at least one lookup table having stored thereon said waveforms.

9. Computer readable medium having stored thereon computer readable instruction which, when executed, executes a method for approximating a discrete-time Bayesian filter estimation that has a time update and a measurement update, said time update being estimated by a method comprising:
a) Factorize
P_{k-1|k-1}=S_{k-1|k-1}S_{k-1|k-1}^{T}
using an assumption that at time k that a posterior density function p(xₖ₋₁|Dₖ₋₁)= [symbol] (\hat{x}_{k-1|k-1},P_{k-1|k-1}) is known
b) Evaluate cubature points (i=1, 2, . . . , m)
X_{i,k-1|k-1}=S_{k-1|k-1}ξᵢ+\hat{x}_{k-1|k-1}
where m=2n_{ₓ}.
c) Evaluate propagated cubature points (i=1, 2, . . . , m)
X_{i,k|k-1}*=f(X_{i,k-1|k-1},uₖ₋₁)
d) Estimate a predicted state
$${\hat{x}}_{k \vert k - 1} = \frac{1}{m} {\sum }_{i = 1}^{m} {X}_{i , k \vert k - 1}^{*}$$
e) Estimate a predicted error covariance
$${P}_{k \vert k - 1} = \frac{1}{m} {\sum }_{i = 1}^{m} {X}_{i , k \vert k - 1}^{*} {X}_{i , k \vert k - 1}^{* T} - {\hat{x}}_{k \vert k - 1} {\hat{x}}_{k \vert k - 1}^{T} + {Q}_{k - 1}$$
wherein said measurement update being estimated by a method comprising:
a) Factorize
P_{k|k-1}=S_{k|k-1}S_{k|k-1}^{T}
b) Evaluate cubature points (i=1, 2, . . . , m)
X_{i,k|k-1}=S_{k|k-1}ξᵢ+\hat{x}_{k|k-1}
c) Evaluate said propagated cubature points (i=1, 2, . . . , m)
Z_{i,k|k-1}=h(X_{i,k|k-1},uₖ)
d) Estimate a predicted measurement
$${\hat{z}}_{k \vert k - 1} = \frac{1}{m} {\sum }_{i = 1}^{m} {Z}_{i , k \vert k - 1}$$
e) Estimate an innovation covariance matrix
$${P}_{zz , k \vert k - 1} = \frac{1}{m} {\sum }_{i = 1}^{m} {Z}_{i , k \vert k - 1} {Z}_{i , k \vert k - 1}^{T} - {\hat{z}}_{k \vert k - 1} {\hat{z}}_{k \vert k - 1}^{T} + {R}_{k}$$
f) Estimate a cross-covariance matrix
$${P}_{xz , k \vert k - 1} = {\sum }_{i = 1}^{m} {ω}_{i} {X}_{i , k \vert k - 1} {Z}_{i , k \vert k - 1}^{T} - {\hat{x}}_{k \vert k - 1} {\hat{z}}_{k \vert k - 1}^{T}$$
g) Estimate a Kalman gain
Wₖ=P_{xz,k|k-1}P_{zz,k|k-1}⁻¹.
h) Estimate an update state
\hat{x}_{k|k}=\hat{x}_{k|k-1}+Wₖ(zₖ−\hat{z}_{k|k-1})
i) Estimate a corresponding error covariance
P_{k|k}=P_{k|k-1}−WₖP_{zz,k|k-1}Wₖ^{T}.
